(19) United States
(12) Patent Application Publication
(10) Pub. No.: US 2010/0217888 A1
(43) Pub. Date: Aug. 26, 2010

(54) TRANSMISSION DEVICE, RECEPTION DEVICE, RATE CONTROL DEVICE, TRANSMISSION METHOD, AND RECEPTION METHOD

(75) Inventors: Yosuke Ukita, Osaka (JP); Kazuhiro Ando, Osaka (JP); Shuya Hosokawa, Osaka (JP)

Correspondence Address: WENDEROTH, LIND & PONACK L.L.P., 1030 15th Street, N.W., Suite 400 East, Washington, DC, 20005-1503, US

(73) Assignee: PANASONIC CORPORATION, Osaka (JP)

(21) Appl. No.: 12/674,522

(22) PCT Filed: Jul. 9, 2009
(86) PCT No.: PCT/JP2009/003218

§ 371 Date: Feb. 25, 2010

(30) Foreign Application Priority Data
Jul. 17, 2008 (JP) 2008-185546

(51) Int. Cl. G06F 15/16

(52) U.S. Cl. 709/234

(57) ABSTRACT

A CPU 14 detects a value of an output bit rate of media data output from a buffer 17, detects a value of a free space of the buffer 17, and divides a value resulted from subtracting a decrease ratio set value from the detected value of the free space by a saved period. As a result, a value of a decrease ratio is obtained. In order to decrease a value of an input bit rate of media data input to the buffer 17 in accordance with the value of the output bit rate, the CPU 14 decreases the value of the input bit rate based on an upper limit of the input bit value that is a value resulted from adding the detected value of the output bit rate and the calculated value of the decrease ratio.

### TECHNICAL FIELD

The present invention relates to an art of performing variable control of a data rate of data to be transmitted.

### BACKGROUND ART

A transmission apparatus includes a buffer for temporarily storing therein data to be transmitted. In a communication in which a status of a transmission path is variable such as a wireless communication and a PLC (Power Line Communication), when the status of the transmission path temporarily deteriorates and as a result a transmission throughput of the communication decreases, a bit rate of data output from a buffer (hereinafter, “output bit rate”) decreases. In other words, the transmission throughput corresponds to the output bit rate. When streaming data such as video data is transmitted, a bit rate of data input to the buffer (hereinafter, “input bit rate”) corresponds to a bit rate of the streaming data.

In the case where streaming data is transmitted via a communication such as a wireless communication and a PLC, if the output bit rate becomes less than the input bit rate due to decrease of the transmission throughput, a data amount of data accumulated in the buffer increases. If the decrease of the transmission throughput continues and as a result the data amount of the data accumulated in the buffer reaches the maximum value of an accumulated amount in the buffer, there occurs an overflow of the buffer, and data to be transmitted will be discarded. This causes interruption of videos and audios.

As a conventional art of preventing occurrence of an overflow caused by decrease of the transmission throughput, the Patent Literatures 1 and 2 each disclose a method of controlling an input bit rate, that is, a bit rate (data rate) of data to be transmitted depending on a status of a transmission path.

According to an art of controlling the input bit rate disclosed in the Patent Literature 1, test packets for measuring a transmission throughput are transmitted, a value of the transmission throughput is measured based on a reach ratio of the test packets, and the input bit rate is controlled such that a value of the input bit rate is the measured value of the transmission throughput.

According to an art of controlling the input bit rate disclosed in the Patent Literature 2, instead of transmitting test packets for measuring the transmission throughput disclosed in the Patent Literature 1, a value of a variation ratio of an accumulated amount per unit time of data accumulated in a buffer and a value of the input bit rate are measured. A value resulted from adding the measured value of the variation ratio of the accumulated amount and the measured value of the input bit rate is determined as a value of the transmission throughput. The input bit rate is controlled such that the value of the input bit rate is the measured value of the transmission throughput.

### Citation List

### Patent Literature

Patent Literature 1: Japanese Patent Application Publication No. 2004-357226

Patent Literature 2: Japanese Patent Application Publication No. 2006-115306

### DISCLOSURE OF INVENTION

### Technical Problem

However, according to the above conventional arts, control is performed such that the input bit rate follows the transmission throughput, and this causes the following problem.

For example, in the case where a wireless transmission path or a power line is used for communication, momentary deterioration of a status of a transmission path frequently occurs. Although this causes temporary decrease of the transmission throughput, the decreased transmission throughput tends to recover shortly thereafter. Accordingly, an overflow of a buffer does not occur even if control for decreasing the input bit rate is not performed. However, according to the above conventional arts, when it is detected that the transmission throughput has decreased, control is performed such that the value of the input bit rate follows the value of the transmission throughput. Accordingly, even in the case where the transmission throughput temporarily decreases, there arises a necessity of decreasing a resolution or a frame rate of videos played back on a reception apparatus. This deteriorates the quality of the videos and gives a viewer an uncomfortable feeling.

In order to prevent the deterioration of the quality of the videos caused by the temporary decrease of the transmission throughput as described above, there is a method in which a time interval of controlling the input bit rate is set long. According to this method, even in the case where the transmission throughput temporarily decreases, the input bit rate does not decrease if the decreased transmission throughput recovers till the input bit rate is controlled next. However, if the time interval of controlling the input bit rate is set long, there occurs a problem that if the decrease of the transmission throughput continues for a certain period, an overflow of the buffer is highly likely to occur till the input bit rate is controlled next. In order to avoid this problem, if the time interval of controlling the input bit rate is set short, there occurs a problem that the quality of videos deteriorates due to the temporary decrease of the transmission throughput.

In view of the above problems, the present invention aims to provide a transmission apparatus, a reception apparatus, a rate control apparatus, a transmission method, and a reception method that are capable of suppressing variation of a data rate of data to be transmitted compared with variation of a status of a transmission path.

### Technical Solution

In order to achieve the above aim, the present invention provides a transmission apparatus that transmits data to a transmission path, the transmission apparatus comprising: a buffer operable to temporarily store therein data to be transmitted to the transmission path; a first detection unit operable to detect a value of an output rate representing a data amount per predetermined time of data output from the buffer; a second detection unit operable to detect a value of a free space of the buffer; a decrease ratio calculation unit operable to calculate a value of a decrease ratio of the free space, by subtracting a predetermined first set value from the value of the free space detected by the second detection unit and dividing a value resulted from the subtraction by a predetermined period; and a control unit operable, in order to decrease an input rate in accordance with the value of the output rate detected by the first detection unit, to perform rate control processing of (a) adding the detected value of the output rate and the value of the decrease ratio calculated by the decrease ratio calculation unit, and (b) controlling the input rate based on a first control value that is a value resulting from the addition.

### ADVANTAGEOUS EFFECTS

According to the above transmission apparatus, when a transmission throughput corresponding to the output rate decreases, it is possible to suppress variation of the data rate of data to be transmitted corresponding to the input rate compared with the variation of the transmission throughput. This can suppress an uncomfortable feeling on an image quality or audio quality caused by rapid change of the data rate, for example.

### BRIEF DESCRIPTION OF DRAWINGS

FIG. 1 shows a structure of a network relating to a first embodiment;

FIG. 2 shows a structure of an AV apparatus as a server apparatus shown in FIG. 1;

FIG. 3 shows an example of a structure of a buffer shown in FIG. 2;

FIG. 4 shows a functional structure of a CPU shown in FIG. 2;

FIG. 5 shows a functional structure of an output bit rate detection unit shown in FIG. 4;

FIG. 6 is a flow chart showing a flow of input bit rate control processing performed by the CPU shown in FIG. 2;

FIG. 7 is a flow chart showing a flow of determination processing of an update value of an input bit rate shown in FIG. 6;

FIG. 8(a), (b), and (c) each show an example of control of an input rate in the case where a transmission throughput decreases;

FIG. 9(a), (b), and (c) each show an example of control of the input rate in the case where the transmission throughput increases;

FIG. 10(a) and (b) show comparison, in terms of method of controlling the input bit rate, between the first embodiment and a conventional art;

FIG. 11(a) and (b) show comparison, in terms of method of controlling the input bit rate, between the first embodiment and a conventional art;

FIG. 12 shows a structure of a network relating to a second embodiment;

FIG. 13 shows a structure of a relay apparatus connected with an AV apparatus as a server apparatus shown in FIG. 12;

FIG. 14 shows a structure of a network relating to a third embodiment;

FIG. 15 shows a structure of an AV apparatus as a server apparatus shown in FIG. 14;

FIG. 16 shows a functional structure of a CPU shown in FIG. 15;

FIG. 17 is a flow chart showing a flow of data rate change processing performed by the CPU shown in FIG. 15;

FIG. 18 shows a structure of an AV apparatus as a client apparatus shown in FIG. 14;

FIG. 19 shows an example of a structure of a buffer shown in FIG. 18;

FIG. 20 shows a functional structure of a CPU shown in FIG. 18;

FIG. 21 shows a functional structure of a transmission throughput detection unit shown in FIG. 20;

FIG. 22 is a flow chart showing a flow of data rate calculation processing performed by the CPU shown in FIG. 18;

FIG. 23 is a flow chart showing a flow of determination processing of an update value of a data rate shown in FIG. 22;

FIG. 24 is a sequence diagram in the case where the AV apparatus as a server apparatus distributes a data stream to the AV apparatus as a client apparatus shown in FIG. 14;

FIG. 25(a), (b), and (c) each show an example of control of the data rate in the case where the transmission throughput decreases; and

FIG. 26(a), (b), and (c) each show an example of control of the data rate in the case where the transmission throughput increases.

### BEST MODE FOR CARRYING OUT THE INVENTION

A first transmission apparatus that is one aspect of the present invention is a transmission apparatus that transmits data to a transmission path, the transmission apparatus comprising: a buffer operable to temporarily store therein data to be transmitted to the transmission path; a first detection unit operable to detect a value of an output rate representing a data amount per predetermined time of data output from the buffer; a second detection unit operable to detect a value of a free space of the buffer; a decrease ratio calculation unit operable to calculate a value of a decrease ratio of the free space, by subtracting a predetermined first set value from the value of the free space detected by the second detection unit and dividing a value resulted from the subtraction by a predetermined period; and a control unit operable, in order to decrease an input rate in accordance with the value of the output rate detected by the first detection unit, to perform rate control processing of (a) adding the detected value of the output rate and the value of the decrease ratio calculated by the decrease ratio calculation unit, and (b) controlling the input rate based on a first control value that is a value resulting from the addition.

A first rate control apparatus that is one aspect of the present invention is a rate control apparatus comprising: a buffer operable to temporarily store therein data to be transmitted to the transmission path; a first detection unit operable to detect a value of an output rate representing a data amount per predetermined time of data output from the buffer; a second detection unit operable to detect a value of a free space of the buffer; a decrease ratio calculation unit operable to calculate a value of a decrease ratio of the free space, by subtracting a predetermined first set value from the value of the free space detected by the second detection unit and dividing a value resulted from the subtraction by a predetermined period; and a control unit operable, in order to decrease an input rate in accordance with the value of the output rate detected by the first detection unit, to perform rate control processing of (a) adding the detected value of the output rate and the value of the decrease ratio calculated by the decrease ratio calculation unit, and (b) controlling the input rate based on a first control value that is a value resulting from the addition.

A first transmission method that is one aspect of the present invention is a transmission method for use in a transmission apparatus that transmits data to a transmission path, the transmission method comprising: a storage step of temporarily storing, in a buffer, data to be transmitted to the transmission path; a first detection step of detecting a value of an output rate representing a data amount per predetermined time of data output from the buffer; a second detection step of detecting a value of a free space of the buffer; a decrease ratio calculation step of calculating a value of a decrease ratio of the free space, by subtracting a predetermined first set value from the value of the free space detected by the second detection step and dividing a value resulted from the subtraction by a predetermined period; and a control step of, in order to decrease an input rate in accordance with the value of the output rate detected by the first detection step, to perform rate control processing of (a) adding the detected value of the output rate and the value of the decrease ratio calculated by the decrease ratio calculation step, and (b) controlling the input rate based on a first control value that is a value resulting from the addition.

With these structures, when a transmission throughput corresponding to the output rate decreases, it is possible to suppress variation of the data rate of data to be transmitted corresponding to the input rate compared with the variation of the transmission throughput.

In the first transmission apparatus, a second transmission apparatus that is one aspect of the present invention further comprises an increase ratio calculation unit operable to calculate a value of an increase ratio of the free space, by subtracting the detected value of the free space from a predetermined second set value and dividing a value resulted from the subtraction by a predetermined period, the second set value being greater than the first set value, wherein in order to increase the input rate in accordance with the detected value of the output rate, the control unit subtracts the value of the increase ratio calculated by the increase ratio calculation unit from the detected value of the output rate, and controls the input rate based on a second control value that is a value resulted from the subtraction.

With this structure, when the transmission throughput corresponding to the output rate increases, it is possible to suppress variation of the data rate of data to be transmitted corresponding to the input rate compared with the variation of the transmission throughput.

In the first transmission apparatus, a third transmission apparatus that is one aspect of the present invention has the structure in which if the detected value of the free space is less than a predetermined first threshold value, the control unit performs the rate control processing.

With this structure, if the value of the free space of the buffer is no less than the first threshold value, it is judged that the transmission throughput is stable. While the transmission throughput is stable, the input rate is not changed. As a result, even if the transmission throughput varies while the transmission throughput is stable, it is possible to keep constant the data rate of data to be transmitted corresponding to the input rate.

In the second transmission apparatus, a fourth transmission apparatus that is one aspect of the present invention has the structure in which if the detected value of the free space is no less than a predetermined second threshold value, the control unit controls the input rate such that a value of the input rate is a fixed value or a predetermined value.

With this structure, if the value of the free space of the buffer is no less than the second threshold value, it is judged that the transmission throughput is stable. While the transmission throughput is stable, the input rate is not changed. As a result, even if the transmission throughput varies while the transmission throughput is stable, it is possible to keep constant the data rate of data to be transmitted corresponding to the input rate.

In the second transmission apparatus, a fifth transmission apparatus that is one aspect of the present invention has the structure in which if a current value of the input rate is greater than the first control value, the control unit controls the input rate such that the value of the input rate is the first control value, and if the current value of the input rate is less than the second control value, the control unit controls the input rate such that the value of the input rate is the second control value.

With this structure, by using the size relationship between the current value of the input rate and each of the first control value and the second control value, it is possible to appropriately control the input rate in accordance with the variation of the transmission throughput.

In the fifth transmission apparatus, a sixth transmission apparatus that is one aspect of the present invention has the structure in which if the current value of the input rate is no less than the second control value and no more than the first control value, the control unit controls the input rate such that the current value of the input rate is kept.

With this structure, it is possible to prevent rapid variation of the value of the input rate.

In the first transmission apparatus, a seventh transmission apparatus that is one aspect of the present invention has the structure in which if the first control value is greater than a maximum value of the data rate that is settable for data to be transmitted, the control unit controls the input rate such that a value of the input rate is the maximum value of the data rate.

With this structure, it is possible to avoid data conversion at a data rate greater than the maximum value of the data rate that is settable for data to be transmitted. This can prevent occurrence of an error during the data conversion.

In the second transmission apparatus, an eighth transmission apparatus that is one aspect of the present invention has the structure in which if the second control value is greater than a maximum value of the data rate that is settable for data to be transmitted, the control unit controls the input rate such that a value of the input rate is the maximum value of the data rate.

With this structure, it is possible to avoid data conversion at a data rate greater than the maximum value of the data rate that is settable for data to be transmitted. This can prevent occurrence of an error during the data conversion.

A first reception apparatus that is one aspect of the present invention is a reception apparatus that receives data from a transmission path, the reception apparatus comprising: a buffer operable to temporarily store therein data received from the transmission path; a first detection unit operable to detect a value of an input rate that represents a data amount per predetermined time of data input to the buffer; a second detection unit operable to detect a value of an accumulated amount of data stored in the buffer; a decrease ratio calculation unit operable to calculate a value of a decrease ratio of the accumulated amount, by subtracting a predetermined first set value from the value of the accumulated amount detected by the second detection unit and dividing a value resulted from the subtraction by a predetermined period; and a control unit operable, in order to decrease an output rate in accordance with the value of the input rate detected by the first detection unit, to perform rate control processing of (a) adding the detected value of the input rate and the value of the decrease ratio calculated by the decrease ratio calculation unit, (b) determining an update value of the output rate based on a first control value that is a value resulting from the addition, and (c) notifying a transmission apparatus of the determined update value of the output rate.

A second rate control apparatus that is one aspect of the present invention is a rate control apparatus, comprising: a buffer operable to temporarily store therein data received from the transmission path; a first detection unit operable to detect a value of an input rate that represents a data amount per predetermined time of data input to the buffer; a second detection unit operable to detect a value of an accumulated amount of data stored in the buffer; a decrease ratio calculation unit operable to calculate a value of a decrease ratio of the accumulated amount, by subtracting a predetermined first set value from the value of the accumulated amount detected by the second detection unit and dividing a value resulted from the subtraction by a predetermined period; and a control unit operable, in order to decrease an output rate in accordance with the value of the input rate detected by the first detection unit, to perform rate control processing of (a) adding the detected value of the input rate and the value of the decrease ratio calculated by the decrease ratio calculation unit, (b) determining an update value of the output rate based on a first control value that is a value resulting from the addition, and (c) notifying a transmission apparatus of the determined update value of the output rate.

A first reception method that is one aspect of the present invention is a reception method for use in a reception apparatus that receives data from a transmission path, the reception method comprising: a storage step of temporarily storing, in a buffer, data received from the transmission path; a first detection step of detecting a value of an input rate that represents a data amount per predetermined time of data input to the buffer; a second detection step of detecting a value of an accumulated amount of data stored in the buffer; a decrease ratio calculation step of calculating a value of a decrease ratio of the accumulated amount, by subtracting a predetermined first set value from the value of the accumulated amount detected by the second detection step and dividing a value resulted from the subtraction by a predetermined period; and a control step of, in order to decrease an output rate in accordance with the value of the input rate detected by the first detection step, performing rate control processing of (a) adding the detected value of the input rate and the value of the decrease ratio calculated by the decrease ratio calculation step, (b) determining an update value of the output rate based on a first control value that is a value resulting from the addition, and (c) notifying a transmission apparatus of the determined update value of the output rate.

With these structures, when a transmission throughput corresponding to the input rate decreases, it is possible to suppress variation of the data rate of data to be transmitted corresponding to the output rate compared with the variation of the transmission throughput.

In the first reception apparatus, a second reception apparatus that is one aspect of the present invention is a reception apparatus that receives data from a transmission path, the reception apparatus comprising: a buffer operable to temporarily store therein data received from the transmission path; a first detection unit operable to detect a value of an input rate that represents a data amount per predetermined time of data input to the buffer; a second detection unit operable to detect a value of an accumulated amount of data stored in the buffer;

a decrease ratio calculation unit operable to calculate a value of a decrease ratio of the accumulated amount, by subtracting a predetermined first set value from the value of the accumulated amount detected by the second detection unit and dividing a value resulted from the subtraction by a predetermined period; and a control unit operable, in order to decrease an output rate in accordance with the value of the input rate detected by the first detection unit, to perform rate control processing of (a) adding the detected value of the input rate and the value of the decrease ratio calculated by the decrease ratio calculation unit, (b) determining an update value of the output rate based on a first control value that is a value resulting from the addition, and (c) notifying a transmission apparatus of the determined update value of the output rate.

With this structure, when the transmission throughput corresponding to the input rate increases, it is possible to suppress variation of the data rate of data to be transmitted corresponding to the output rate compared with the variation of the transmission throughput.

In the first reception apparatus, a third reception apparatus that is one aspect of the present invention has the structure in which if the detected value of the accumulated amount is less than a predetermined first threshold value, the control unit performs the rate control processing.

With this structure, if the value of the accumulated amount in the buffer is no less than the first threshold value, it is judged that the transmission throughput is stable. While the transmission throughput is stable, the output rate is not changed. As a result, even if the transmission throughput varies while being stable, it is possible to keep constant the data rate of data to be transmitted corresponding to the output rate.

In the second reception apparatus, a fourth reception apparatus that is one aspect of the present invention has the structure in which if the detected value of the accumulated amount is no less than a predetermined second threshold value, the control unit determines the update value of the output rate such that a value of the output rate is a fixed value or a predetermined value.

With this structure, if the value of the accumulated amount in the buffer is no less than the second threshold value, it is judged that the transmission throughput is stable. While the transmission throughput is stable, the output rate is not changed. As a result, even if the transmission throughput varies while being stable, it is possible to keep constant the data rate of data to be transmitted corresponding to the output rate.

In the second reception apparatus, a fifth reception apparatus that is one aspect of the present invention has the structure in which if a current value of the output rate is greater than the first control value, the control unit determines the update value of the output rate as the first control value, and if the current value of the output rate is less than the second control value, the control unit determines the update value of the output rate as the second control value.

With this structure, by using the size relationship between the current value of the input rate and each of the first control value and the second control value, it is possible to appropriately control the input rate in accordance with the variation of the transmission throughput.

In the fifth reception apparatus, a sixth reception apparatus that is one aspect of the present invention has the structure in which if the current value of the output rate is no less than the second control value and no more than the first control value, the control unit determines the update value of the output rate such that the current value of the output rate is kept.

With this structure, it is possible to prevent rapid variation of the value of the output rate.

The following describes embodiments of the present invention with reference to the drawings.

### First Embodiment

A first embodiment of the present invention is described below with reference to the drawings.

Structure and Operations of Network

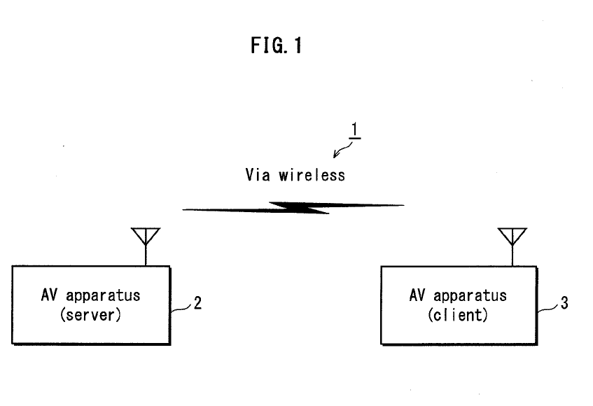

FIG. 1 shows the structure of a network relating to the first embodiment. A network 1 includes AV apparatuses 2 and 3.

In the first embodiment, the AV apparatus 2 is an AV apparatus as a server apparatus that stores therein media data and transmits the stored media data. The AV apparatus 3 is an AV apparatus as a client apparatus that receives media data transmitted from other apparatus, and plays back and displays the received media data. The AV apparatus 2 is, for example, a recorder that has a communication function and is capable of storing video content data, such as an HDD recorder and a Blu-ray Disk™ recorder. The AV apparatus 3 is, for example, a display that has a communication function such as a TV. The communication function is realized by wireless communication such as a wireless LAN (Local Area Network) compliant with the IEEE802.11 standard, power line communication such as the HD-PLC™, communication such as the Ethernet™, coaxial cable communication, or the like. In FIG. 1, the communication function is realized by the wireless communication.

The AV apparatus 2 streams video content data accumulated therein, for example. The AV apparatus 3 receives the streamed video content data, and plays back and displays the received video content data. This enables the viewer to watch, on the AV apparatus 3, videos generated from the video content data accumulated in the AV apparatus 2.

The following describes the details of the AV apparatus 2 as a server apparatus with reference to the drawings. Note that since a prevalent AV apparatus is available for the AV apparatus 3 as a client apparatus, the detailed description thereof is omitted here.

<Structure of AV Apparatus (as Server Apparatus)>

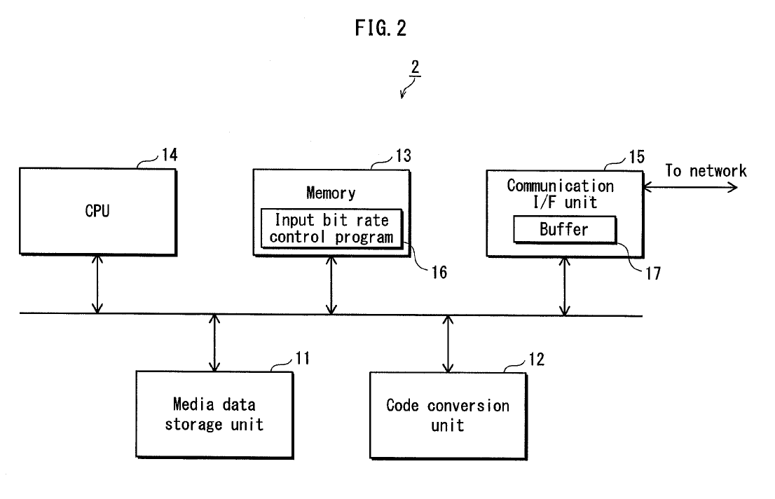

FIG. 2 shows a structure of the AV apparatus 2 as a server apparatus shown in FIG. 1. The AV apparatus 2 includes a media data storage unit 11, a code conversion unit 12, a memory 13, a CPU (Central Processing Unit) 14, and a communication interface unit (hereinafter, “communication I/F unit”) 15.

The media data storage unit 11 is, for example, an HDD, and has a function of storing therein media contents such as video data and audio data.

The code conversion unit 12 has a function of changing a bit rate (data rate) of media data such as video data and audio data. A bit rate of media data is changed using the following methods. For example, a method is used in which media data that has been compressed and encoded is decoded and then re-encoded to a different bit rate. Also, a method called transcoding is used in which media data that has been compressed and encoded is re-encoded to a different bit rate without being decoded. Alternatively, as long as input media data can be converted into media data having a different bit rate and can be output, any conversion method and encoding method may be employed. Note that video data and audio data for example input to the code conversion unit 12 do not necessarily need to be compressed and encoded. For example, it may be employed that video data and audio data that have not been compressed and encoded are input, compression processing and encoding processing are performed, and the video data and the audio data that have been compressed and encoded are output.

The memory 13 is for example a semiconductor memory such as a ROM (Read Only Memory) and a RAM (Random Access Memory). The memory 13 stores therein programs such as various types of control programs and various types of application programs. For example, the memory 13 stores therein a program 16 for controlling a data amount per predetermined time of media data to be input to a buffer 17 of the communication I/F unit 15, which is described later. This program is hereinafter referred to as an “input bit rate control program” 16. Also, the memory 13 has an area to be used by the CPU 14 for performing operations.

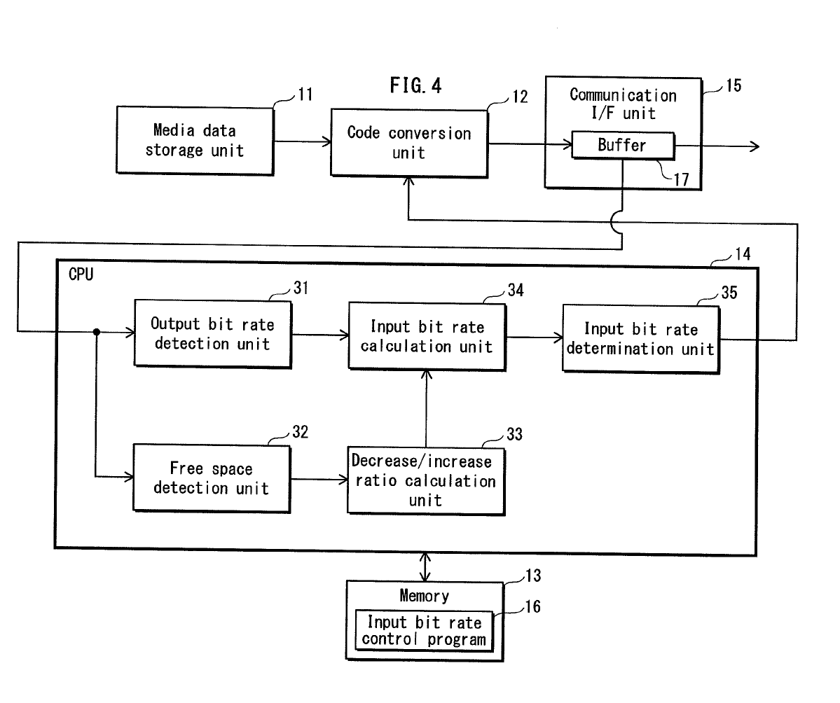

The CPU 14 has a function of performing various types of controls on the whole AV apparatus 2 and performing various types of calculations, by reading a program stored in the memory 13 and executing the read program. For example, the CPU 14 reads the input bit rate control program 16 from the memory 13, and executes the read input bit rate control program 16. Note that this processing is described later with reference to FIG. 4 to FIG. 7.

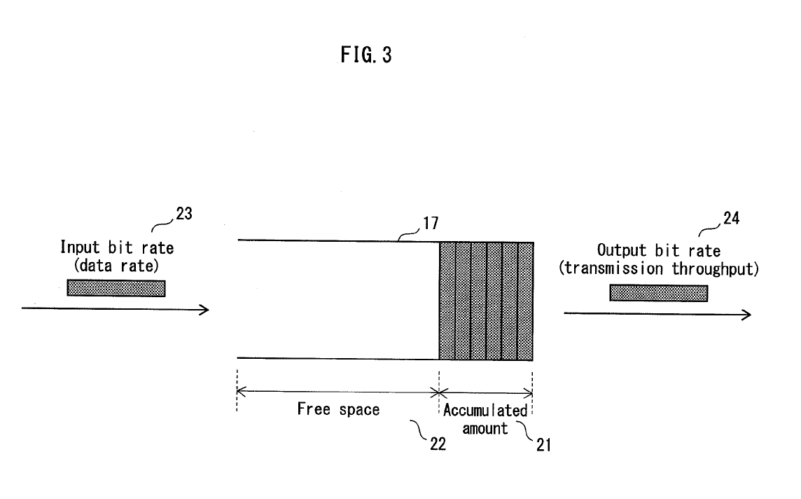

The communication I/F unit 15 has a function of transmitting and receiving data via a network, such as a function of performing modulation and demodulation of data signal and media access control. The communication I/F unit 15 is a communication I/F unit for wireless communication, here. The communication I/F unit 15 includes therein the buffer 17 that is a transmission buffer. Note that the buffer 17 is described later with reference to FIG. 3.

For example, in order to transmit media data to the AV apparatus 3 as a client apparatus, the CPU 14 executes the input bit rate control program 16 to calculate an update value of an input bit rate, which is described later. The code conversion unit 12 changes a bit rate (data rate) of the media data stored in the media data storage unit 11 based on the calculated update value of the input bit rate. Then, the communication I/F unit 15 temporarily stores, in the buffer 17, the media data whose bit rate has been changed, and transmits the media data to the AV apparatus 3 as a client apparatus via the network.

In this way, by including the code conversion unit 12 for changing a bit rate (data rate) of data input to the buffer 17 in the AV apparatus 2, it is possible to immediately change the input bit rate.

<Structure of Buffer>

FIG. 3 shows an example of a structure of the buffer 17 shown in FIG. 2.

An accumulated amount 21 represents a data amount of data accumulated in the buffer 17. A free space 22 represents a remaining data amount of data accumulatable in the buffer 17. The unit of data amount of the accumulated amount 21 and the free space 22 can be represented by bit, byte, or the like. In the description of the first embodiment, the unit “bit” is used as the unit of data amount.

An input bit rate 23 represents a data amount per unit time of media data input to the buffer 17. An output bit rate 24 represents a data amount per unit time of media data output from the buffer 17. In the description of the first embodiment, the unit “bps (bit per second)” is used as the unit of the input bit rate 23 and the output bit rate 24. Here, the input bit rate 23 corresponds to a bit rate (data rate) of media data output from the code conversion unit 12. The output bit rate 24 corresponds to a transmission throughput in transmission of media data by the communication I/F unit 15.

The buffer 17 outputs media data that has been input in order of the input in accordance with the FIFO principle. Here, if the input bit rate 23 is equal to the output bit rate 24, the accumulated amount 21 of the buffer 17 does not vary. If the input bit rate 23 is not equal to the output bit rate 24, the accumulated amount 21 of the buffer 17 increases or decreases depending on the difference between the input bit rate 23 and the output bit rate 24. In other words, if the input bit rate 23 is greater than the output bit rate 24, the accumulated amount 21 of the buffer 17 increases. If the input bit rate 23 is less than the output bit rate 24, the accumulated amount 21 of the buffer 17 decreases.

For example, if the input bit rate 23 is 12 Mbps and the output bit rate 24 is 8 Mbps, the accumulated amount 21 of the buffer 17 increases at 4 Mbps, in other words, the free space 22 of the buffer 17 decreases at 4 Mbps. On the other hand, if the input bit rate 23 is 6 Mbps and the output bit rate 24 is 9 Mbps, the accumulated amount 21 of the buffer 17 decreases at 3 Mbps, in other words, the free space 22 of the buffer 17 increases at 3 Mbps.

<Functional Structure of CPU>

FIG. 4 shows a functional structure of the CPU 14 shown in FIG. 2. Note that FIG. 4 also shows other compositional elements of the AV apparatus 2 for facilitating understanding of the functional structure of the CPU 14.

The CPU 14 reads the input bit rate control program 16 stored in the memory 13, and executes the read input bit rate control program 16. As a result, the CPU 14 functions as an output bit rate detection unit 31, a free space detection unit 32, a decrease/increase ratio calculation unit 33, an input bit rate calculation unit 34, and an input bit rate determination unit 35.

The output bit rate detection unit 31 detects a value of the output bit rate 24 of media data output from the buffer 17, that is, a value of the transmission throughput, and outputs the detected value of the output bit rate 24 to the input bit rate calculation unit 34.

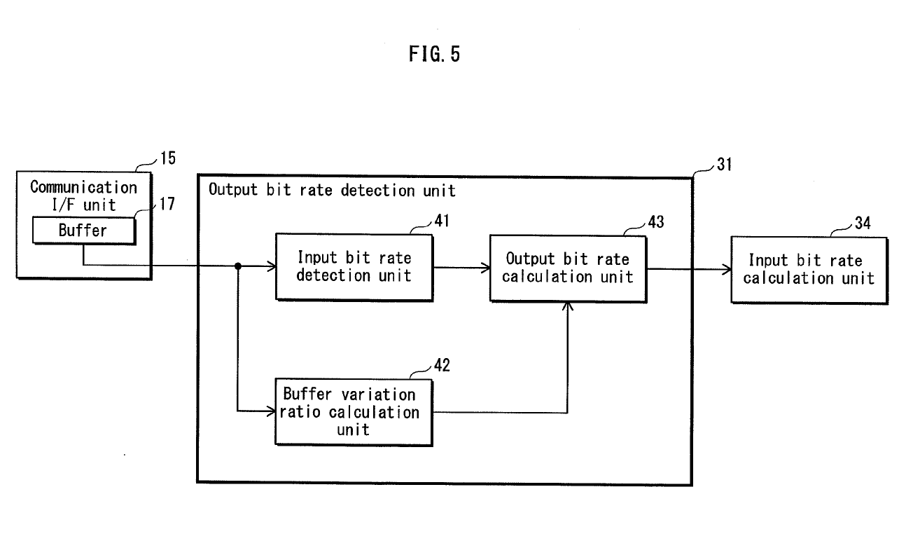

Here, the functional structure of the output bit rate detection unit 31 is described with reference to FIG. 5. FIG. 5 shows a functional structure of the output bit rate detection unit 31 shown in FIG. 4. Note that FIG. 5 also shows the communication I/F unit 15 and the input bit rate calculation unit 34 for clarifying the connection relationship among the internal elements of the output bit rate detection unit 31, the communication I/F unit 15, and the input bit rate calculation unit 34.

The output bit rate detection unit 31 functions as an input bit rate detection unit 41, a buffer variation ratio calculation unit 42, and an output bit rate calculation unit 43.

The input bit rate detection unit 41 detects a data amount per unit time of media data input to the buffer 17, and outputs the detected data amount to the output bit rate calculation unit 43, as a value of the input bit rate 23. Note that the input bit detection unit 41 may detect, as a value of the input bit rate 23, an update value of the input bit rate output from the input bit rate determination unit 35 to the code conversion unit 12, which is described later.

The buffer variation ratio calculation unit 42 calculates the increase and the decrease of the accumulated amount 21 of the buffer 17 per unit time, as a variation ratio, and then outputs the calculated variation ratio to the output bit rate calculation unit 43. Note that the increase of the accumulated amount 21 as the variation ratio is represented by a positive value and the decrease of the accumulated amount 21 as the variation ratio is represented by a negative value.

The output bit rate calculation unit 43 subtracts the value of the variation ratio input by the buffer variation ratio calculation unit 42 from the value of the input bit rate 23 input by the input bit rate detection unit 41, thereby to calculate a value of the output bit rate 24 (output bit rate=input bit rate−variation ratio), and outputs the calculated value of the output bit rate 24 to the input bit rate calculation unit 34.

The free space detection unit 32 detects a value of the free space 22 of the buffer 17, and outputs the detected value of the free space 22 to the decrease/increase ratio calculation unit 33.

The decrease/increase ratio calculation unit 33 calculates a value of a decrease ratio and a value of an increase ratio that are permissible for the free space 22 of the buffer 17, using a value of the free space 22 of the buffer 17 input from the free space detection unit 32. Then, the decrease/increase ratio calculation unit 33 outputs the calculated value of the decrease ratio and the calculated value of the increase ratio to the input bit rate calculation unit 34.

The decrease/increase ratio calculation unit 33 calculates the increase ratio in the following manner. The decrease/increase ratio calculation unit 33 subtracts the value of the free space 22 of the buffer 17 from an increase ratio set value which has been set beforehand, and divides a value resulted from the subtraction by a certain period which has been set beforehand (hereinafter, “saved period”), thereby to calculate an value of the increase ratio (increase ratio=(increase ratio set value−free space)/saved period). Note that the increase ratio set value is a desired maximum value of the free space 22 after an elapse of the saved period, which is obtained by controlling the input bit rate 23 to adjust the increase or decrease of the free space 22. The increase ratio set value is used mainly for controlling the input bit rate to increase. The calculated value of the increase ratio is a value of the increase ratio of the free space 22 per unit time that is necessary for increasing the value of the free space 22 to reach the increase ratio set value after an elapse of the saved period.

Also, the decrease/increase ratio calculation unit 33 calculates the decrease ratio in the following manner. The decrease/increase ratio calculation unit 33 subtracts a decrease ratio set value which has been set beforehand from a value of the free space 22 of the buffer 17, and divides a value resulted from the subtraction by the saved period, thereby to calculate a value of the decrease ratio (decrease ratio=(free space−decrease ratio set value)/saved period). Note that the decrease ratio set value is a desired minimum value of the free space 22 after an elapse of the saved period, which is obtained by controlling the input bit rate 23 to adjust the increase or decrease of the free space 22. The decrease ratio set value is used mainly for controlling the input bit rate to decrease. The calculated value of the decrease ratio is a value of the decrease ratio of the free space 22 per unit time that is necessary for decreasing the value of the free space 22 to reach the decrease ratio set value after an elapse of the saved period.

Note that the increase ratio set value is greater than the decrease ratio set value. Although the increase ratio set value can be set to an arbitrary value in design processing, the increase ratio set value may be set to the maximum value of the accumulated amount 21 of the buffer 17, for example. Although the decrease ratio set value can be set to an arbitrary value in design processing, the decrease ratio set value may be set to zero, for example. Although the saved periods respectively used for calculating the increase ratio and the decrease ratio can be set to an arbitrary value in design processing, the saved periods may be set to a duration of transmission path errors that continuously occur, for example. Note that the saved periods respectively used for calculating the increase ratio and the decrease ratio may be the same value, or values different from each other.

The input bit rate calculation unit 34 adds a value of the decrease ratio input by the decrease/increase ratio calculation unit 33 to a value of the output bit rate input by the output bit rate detection unit 31, and outputs a value resulted from the addition to the input bit rate determination unit 35, as an upper limit value of the input bit rate (upper limit value of input bit rate=output bit rate+decrease ratio). Note that the upper limit value of the input bit rate is an upper limit value of the input bit rate that is permissible for updating the input bit rate.

Also, the input bit rate calculation unit 34 subtracts a value of the increase ratio input by the decrease/increase ratio calculation unit 33 from a value of the output bit rate input by the output bit rate detection unit 31, and outputs a value resulted from the subtraction to the input bit rate determination unit 35, as a lower limit value of the input bit rate (lower limit value of input bit rate=output bit rate−increase ratio). Note that the lower limit value of the input bit rate is a lower limit value of the input bit rate that is permittable for updating the input bit rate.

The input bit rate determination unit 35 determines an update value of the input bit rate based on a current value of the input bit rate detected by the input bit rate detection unit 41 shown in FIG. 5, the upper limit value of the input bit rate and the lower limit value of the input bit rate input by the input bit rate calculation unit 34, and a maximum value of the data rate settable for media data to be transmitted. The input bit rate determination unit 35 notifies the code conversion unit 12 of the determined update value of the input bit rate. Note that the update value of the input bit rate to be output to the code conversion unit 12 may be used as the current value of the input bit rate. Note that the code conversion unit 12 changes a bit rate (data rate) of media data stored in the media data storage unit 11 based on the update value of the input bit rate notified from the input bit rate determination unit 35 of the CPU 14, and outputs the media data whose bit rate has been changed to the buffer 17 of the communication I/F unit 15.

Specifically, if the current value of the input bit rate falls within a range of the lower limit value of the input bit rate to the upper limit value of the input bit rate, that is, if the current value of the input bit rate is no less than the lower limit value of the input bit rate and no more than the upper limit value of the input bit rate, the input bit rate determination unit 35 sets the update value of the input bit rate to the current value of the input bit rate. If the current value of the input bit rate is less than the lower limit value of the input bit rate, the input bit rate determination unit 35 sets the update value of the input bit rate to the lower limit value of the input bit rate. If the current value of the input bit rate is greater than the upper limit value of the input bit rate, the input bit rate determination unit 35 sets the update value of the input bit rate to the upper limit value of the input bit rate.

Furthermore, if the set update value of the input bit rate is greater than the maximum value of the data rate that is settable for media data to be transmitted as described above, the input bit rate determination unit 35 again sets the update value of the input bit rate to the maximum value of the data rate.

According to the structure of the CPU 14 described with reference to FIG. 4 and FIG. 5, by simply detecting the status of the buffer, specifically the free space 22 of the buffer 17, the input bit rate 23, the variation ratio of the free space 22 of the buffer 17, it is possible to control the input bit rate. This facilitates control of the input bit rate, and enables the simplification of the structure of the AV apparatus 2.

<Operations of CPU>

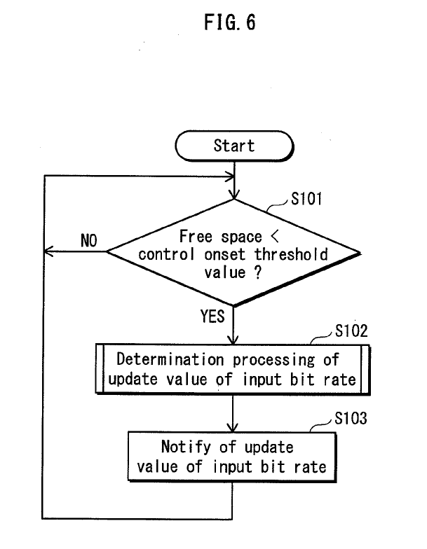

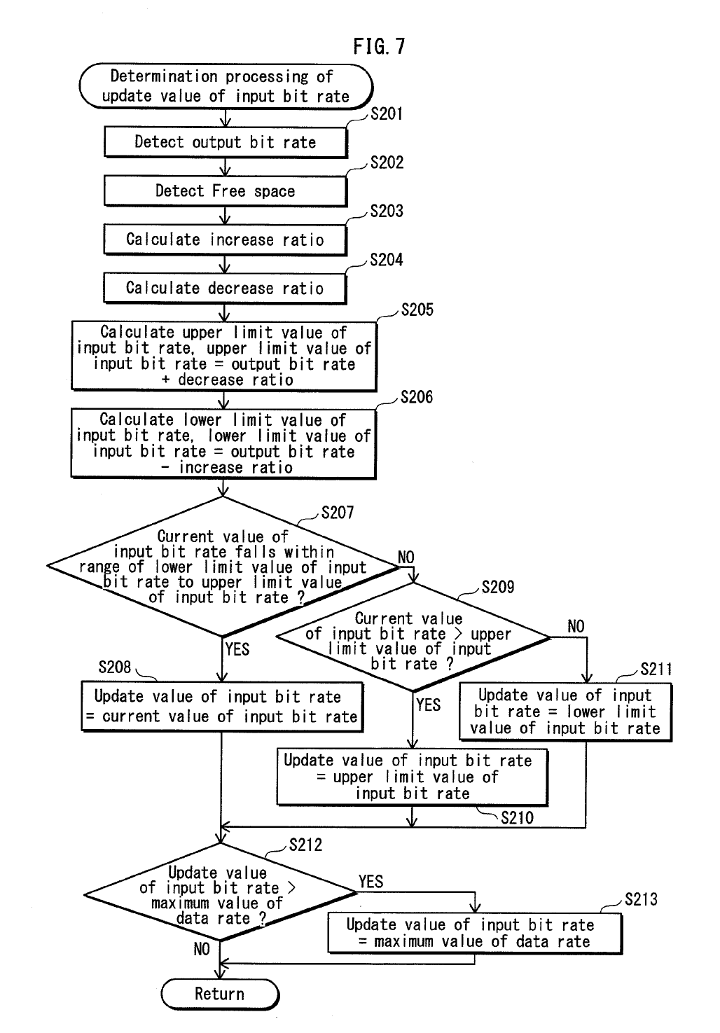

FIG. 6 is a flow chart showing a flow of input bit rate control processing performed by the CPU 14 shown in FIG. 2. Note that the CPU 14 reads the input bit rate control program 16 stored in the memory 13, and executes the read input bit rate control program 16, thereby to perform processing in flow charts shown in FIG. 6 and FIG. 7 that is described later.

The CPU 14 judges whether a value of the free space 22 of the buffer 17 is less than a control onset threshold value that has been set beforehand (Step S101).

If judging that the free space 22 is no less than the control onset threshold value (S101: NO), the CPU 14 repeatedly performs processing of Step S101, and does not update the input bit rate 23. For example, while the value of the free space 22 is no less than the control onset threshold value, the CPU judges that the transmission throughput is stable. Accordingly, the CPU 14 does not update the input bit rate 23. Also, while the value of the free space 22 becomes no less than the control onset threshold value due to recovery of the deteriorated status of the transmission path and then becomes less than the control onset threshold value, the CPU 14 judges that the transmission throughput is stable. Accordingly, the CPU 14 fixes the value of the input bit rate 23 to a value of the input bit rate 23 as at the time when the value of the free space 22 becomes no less than the control onset threshold value. In this way, if the value of the free space 22 of the buffer 17 is no less than the control onset threshold value, the CPU 14 judges that the transmission throughput is stable. Accordingly, even if the free space 22 of the buffer 17 momentarily varies, the CPU 14 does not update the input bit rate 23 as long as the transmission throughput is stable. As a result, while the transmission throughput is stable, the value of the input bit rate 23 is kept to a constant value. Accordingly, in the case where the transmission throughput is stable during transmission of video data for example, there never occurs a change such as decrease of a resolution or a frame rate of videos played back on the AV apparatus 3 as a client apparatus. This enables the viewer to watch the videos without uncomfortable feeling.

On the other hand, if judging that the value of the free space 22 is less than the control onset threshold value (S101: YES), the CPU 14 performs updated input bit rate determination processing shown in FIG. 7 to determine the update value of the input bit rate (Step S102). Then, the input bit rate determination unit 35 of the CPU 14 notifies the code conversion unit 12 of the update value of the input bit rate determined in Step S102 (Step S103), and then performs processing of Step S101. The code conversion unit 12 changes a bit rate (data rate) of media data stored in the media data storage unit 11 based on the notified update value of the input bit rate, and outputs the media data whose bit rate has been changed to the buffer 17 of the communication I/F unit 15. The communication I/F unit 15 transmits media data accumulated in the buffer 17 to the AV apparatus 3 as a client apparatus or the like via the network.

<Determination Processing of Update Value of Input Bit Rate>

FIG. 7 is a flow chart showing a flow of the determination processing of an update value of the input bit rate (Step S102) shown in FIG. 6.

In the output bit rate detection unit 31, the input bit rate detection unit 41 detects a value of the input bit rate 23 of media data input to the buffer 17, and the buffer variation ratio calculation unit 42 calculates a value of the variation ratio of the accumulated amount 21 of the buffer 17. Then, the output bit rate calculation unit 43 subtracts the calculated value of the variation ratio from the detected value of the input bit rate 23, thereby to calculate a value of the output bit rate 24 (Step S201).

The free space detection unit 32 detects a value of the free space 22 of the buffer 17 (Step S202). The decrease/increase ratio calculation unit 33 subtracts the value of the free space 22 detected in Step S202 from the increase ratio set value, and divides a value resulted from the subtraction by the saved period, thereby to calculate a value of the increase ratio (Step S203). Also, the decrease/increase ratio calculation unit 33 subtracts the decrease ratio set value from the value of the free space 22 detected in Step S202, and divides a value resulted from the subtraction by the saved period, thereby to calculate a value of the decrease ratio (Step S204).

The input bit rate calculation unit 34 adds the value of the decrease ratio calculated in Step S204 to the value of the output bit rate detected in Step S201, and sets a value resulted from the addition to the upper limit value of the input bit rate (Step S205). Also, the input bit rate calculation unit 34 subtracts the value of the increase ratio calculated in Step S203 from the value of the output bit rate detected in Step S201, and sets a value resulted from the subtraction to the lower limit value of the input bit rate (Step S206).

The input bit rate determination unit 35 judges whether a current value of the input bit rate falls within a range of the lower limit value of the input bit rate obtained in Step S206 to the upper limit value of the input bit rate obtained in Step S205 (Step S207).

If judging that the current value of the input bit rate falls within the range (S207: YES), the input bit rate determination unit 35 sets the update value of the input bit rate to the current value of the input bit rate (Step S208), and then proceeds to processing of Step S212. By performing these processing, in the case where the recovered transmission throughput again decreases, or in the case where the decreased transmission throughput recovers, the input bit rate is not updated as long as the current value of the input bit rate falls within the range of the lower limit value of the input bit rate to the upper limit value of the input bit rate. Accordingly, as long as the current value of the input bit rate falls within the range, the input bit rate is stable without being varied even if the transmission throughput varies. This can avoid the rapid increase or decrease of the resolution or the frame rate of videos played back on the AV apparatus 3 as a client apparatus, for example. Accordingly, the viewer can watch the videos having a stable quality.

On the other hand, if judging that the current value of the input bit rate does not fall within the range (S207: NO), the input bit rate determination unit 35 further judges whether the current value of the input bit rate is greater than the upper limit value of the input bit rate (Step S209).

If the input bit rate determination unit 35 judges that the input bit rate is greater than the upper limit value of the input bit rate (S209: YES), it means that the upper limit value of the input bit rate is less than the current value of the input bit rate due to the decrease of the output bit rate or the decrease of the free space 22 of the buffer 17. Accordingly, the input bit rate determination unit 35 sets the update value of the input bit rate to the upper limit value of the input bit rate in order to decrease the input bit rate (Step S210), and then proceeds to processing shown in Step S212.

On the other hand, if the input bit rate determination unit 35 judges that the current value of the input bit rate is no more than the upper limit value of the input bit rate, that is, judges that the current value of the input bit rate is less than the lower limit value of the input bit rate (S209: NO), it means that the lower limit value of the input bit rate is greater than the current value of the input bit rate due to the increase of the output bit rate or the increase of the free space 22 of the buffer 17. Accordingly, the input bit rate determination unit 35 sets the update value of the input bit rate to the lower limit value of the input bit rate in order to increase the input bit rate (Step S211), and then proceeds to processing of Step S212.

The input bit rate determination unit 35 judges whether the update value of the input bit rate set in either of Steps S208, S210, and S211 is greater than the maximum value of the data rate that is settable for media data to be transmitted (Step S212). If judging that the set update value of the input bit rate is greater than the maximum value of the data rate (S212: YES), the input bit rate determination unit 35 re-sets the update value of the input bit rate to the maximum value of the data rate (Step S213) to perform Step S103 shown in FIG. 6. By performing these processing, there never occurs that the update value of the input bit rate notified to the code conversion unit 12 exceeds the maximum value of the data rate. Accordingly, the code conversion unit 12 does not change the bit rate (data rate) of media data based on the update value of the input bit rate that exceeds the maximum value of the data rate, and it is possible to avoid the occurrence of an error during the change. On the other hand, if judging that the set update value of the input bit rate is no more than the maximum value of the data rate (S212: NO), the input bit rate determination unit 35 does not perform re-set the update value of the input bit rate, and performs Step S103 shown in FIG. 6.

<Control Example of Input Bit Rate>

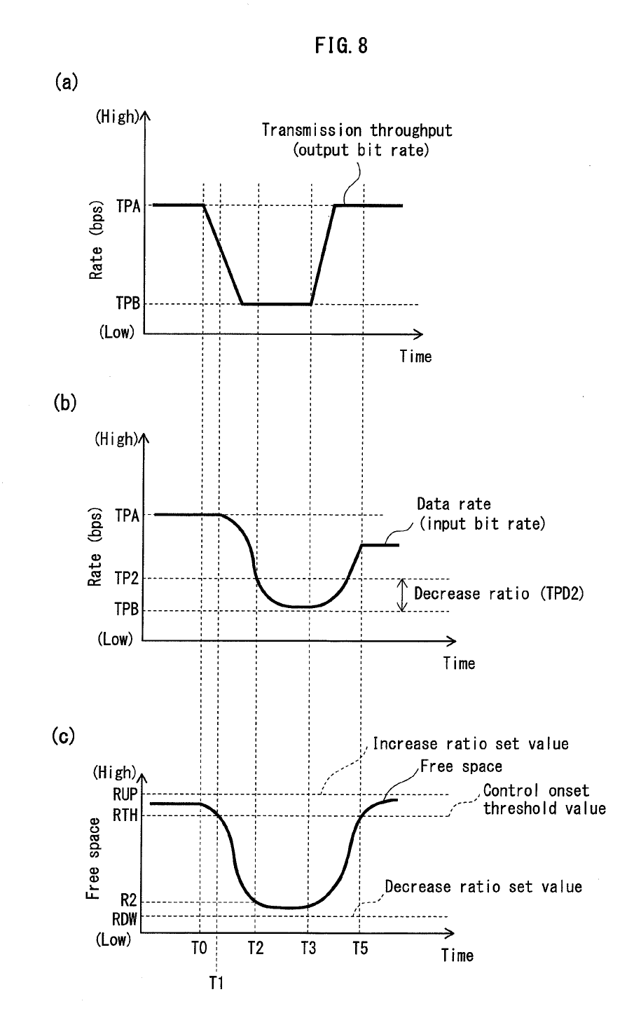

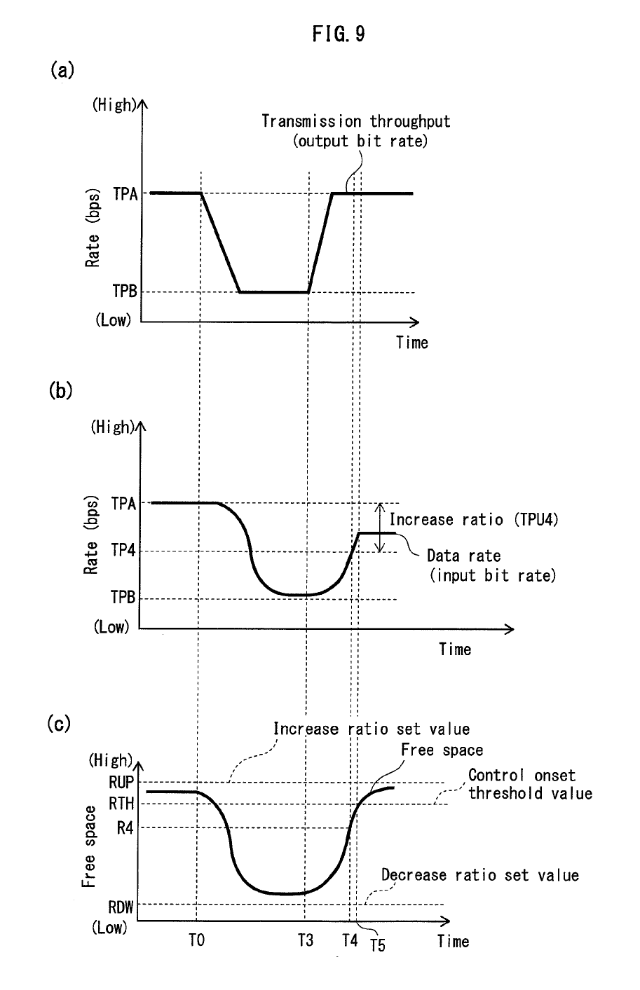

The following describes, as an example of controlling the input bit rate, the control of an input bit rate of media data input to the buffer 17, that is, a data rate in the case where the transmission throughput decreases and then recovers after an elapse of a certain period, with reference to FIG. 8 and FIG. 9.

FIG. 8(a) and FIG. 9 (a) each show the temporal variation of the transmission throughput, that is, the output bit rate 24 of media data output from the buffer 17. The vertical axis represents rate (bps), and the horizontal axis represents time. FIG. 8(a) and FIG. 9(a) each show that, at a time T0, the status of the transmission path deteriorates and the transmission throughput rapidly decreases. At a time T3 after an elapse of a certain time period, the deteriorated status of the transmission path recovers and the transmission throughput starts increasing rapidly.

FIG. 8(b) and FIG. 9(b) each show the temporal variation of a data rate of media data to be transmitted, that is, the input bit rate 23 of the media data input to the buffer 17. The vertical axis represents rate (bps), and the horizontal axis represents time.

FIG. 8(c) and FIG. 9(c) each show the temporal variation of the free space 22 of the buffer 17. The vertical axis represents free space, and the horizontal axis represents time.

<Control of Decreasing Input Bit Rate when Transmission Throughput Decreases>

The following describes an example of controlling the input bit rate when the transmission throughput decreases, with reference to FIG. 8(a) to FIG. 8(c).

At the time T0, the status of the transmission path deteriorates, and the transmission throughput, that is, the output bit rate 24 of media data output from the buffer 17 starts decreasing. The value of the output bit rate 24 decreases from TPA to TPB. With the decrease of the output bit rate 24, the free space 22 decreases. Then, till the time T1, the value of the free space 22 is no less than the control onset threshold value RTH, and accordingly the value of the input bit rate 23 is not changed (see Step S101 in FIG. 6). In this way, while the value of the free space 22 is no less than the control onset threshold value RTH, the value of the input bit rate 23 does not decrease even if the value of the output bit rate 24 decreases.

The value of the free space 22 decreases depending on the difference between the value of the input bit rate 23 and the value of the output bit rate 24. Suppose that, at the time T1, the free space 22 becomes less than the control onset threshold value RTH. The CPU 14 starts determining the update value of the input bit rate and notifying the code conversion unit 12 of the update value of the input bit rate. While the value of the free space 22 is less than the control onset threshold value RTH, the CPU 14 continues to determine the update value of the input bit rate and notify the code conversion unit 12 of the update value of the input bit rate (see FIG. 6).

The output bit rate detection unit 31 of the CPU 14 detects the value of the output bit rate 24. The free space detection unit 32 detects the value of the free space 22 of the buffer 17. The decrease/increase ratio calculation unit 33 calculates a value of the increase ratio and a value of the decrease ratio. The input bit rate calculation unit 34 calculates the upper limit value of the input bit rate and the lower limit value of the input bit rate (see Steps S201 to S206 in FIG. 7). Here, the input bit rate determination unit 35 judges that the current value of the input bit rate is greater than the upper limit value of the input bit rate, and sets the update value of the input bit rate to the upper limit value of the input bit rate (see Steps S207, 5209, and 5210 in FIG. 7). Here, the input bit rate determination unit 35 judges that the update value of the input bit rate is no more than the maximum value of the data rate (see Step S212 in FIG. 7), and notifies the code conversion unit 12 of the update value of the input bit rate (a value that is equal to the upper limit value of the input bit rate, here) without re-setting the update value of the input bit rate (see Step S103 in FIG. 6). As a result, the value of the input bit rate 23 gradually decreases while being kept greater than the value of the output bit rate 24.

For example, suppose that the decrease ratio set value is RDW, the saved period is Ta, the free space 22 of the buffer 17 at the time T2 is R2, and the output bit rate 24 at the time T2 is TPB. The decrease ratio at the time T2 expressed by TPD2 is as follows: TPD2=(R2−RDW)/Ta. The upper limit value of the input bit rate at the time T2 is a value TPB+TPD2, which is a value resulted from adding the value of the decrease ratio at the time T2 (TPD2) to the value of the output bit rate 24 at the time T2 (TPB). The update value of the input bit rate at the time T2 expressed by TP2 is as follows: TP2=TPB+TPD2.

<Control of Increasing Input Bit Rate when Transmission Throughput Increases>

The following describes an example of controlling the input bit rate to increase in the case where the transmission throughput increases, with reference to FIG. 9.

Suppose that, at the time T3, the transmission throughput decreased due to the deteriorated status of the transmission path recovers due to recovery of the status of the transmission path.

The output bit rate detection unit 31 of the CPU 14 detects the value of the output bit rate. The free space detection unit 32 detects the value of the free space 22 of the buffer 17. The decrease/increase ratio calculation unit 33 calculates a value of the increase ratio and a value of the decrease ratio. The input bit rate calculation unit 34 calculates the upper limit value of the input bit rate and the lower limit value of the input bit rate (see Steps S201-S206 in FIG. 7). Here, the input bit rate determination unit 35 judges that the current value of the input bit rate is less than the lower limit value of the input bit rate, and sets the update value of the input bit rate to the lower limit value of the input bit rate (see Steps S207, S209, and S211 in FIG. 7). Here, the input bit rate determination unit 35 judges that the update value of the input bit rate is no more than the maximum value of the data rate (see Step S212 in FIG. 7), and notifies the code conversion unit 12 of the update value of the input bit rate (a value that is equal to the lower limit value of the input bit rate, here) without re-setting the update value of the input bit rate (see Step S103 in FIG. 6). As a result, the value of the input bit rate 23 gradually increases while being kept less than the value of the output bit rate 24.

For example, suppose that the increase ratio set value is RUP, the saved period is Ta, the free space 22 of the buffer 17 at a time T4 is R4, and the output bit rate 24 at the time T4 is TPA. The increase ratio at the time T4 expressed by TPU4 is as follows: TPU4=(RUP−R4)/Ta. The lower limit value of the input bit rate at the time T4 is TPA−TPU4, which is a value resulted from subtracting the value of the increase ratio (TPU4) at the time T4 from the value of the output bit rate 24 at the time T4 (TPA). The update value of the input bit rate at the time T4 expressed by TP4 is as follows: TP4=TPA−TPU4.

If, at the time T3, the deteriorated status of the transmission path recovers and the transmission throughput, that is, the output bit rate 24 of media data output from the buffer 17 increases, the free space 22 starts increasing. Then, if, at a time T5, the value of the free space 22 of the buffer 17 becomes no less than the control onset threshold value RTH, the value of the input bit rate is fixed (see Step S101 in FIG. 6).

<Numerical Example of Controlling Input Bit Rate>

The following describes a numerical example of the control of the input bit rate relating to the first embodiment. The initial condition is that the maximum value of the data rate is 12 Mbps, the maximum value of the accumulated amount of the buffer 17 is 500 packets (hereinafter, “Pkt”), the control onset threshold value is 450 Pkt, the increase ratio set value is 500 Pkt, the decrease ratio set value is 50 Pkt, and the saved period is 500 msec. Note that 1 Pkt is equal to 1500 bytes.

<Numerical Example in Decrease of Transmission Throughput>

Suppose that the current value of the input bit rate 23 is 12 Mbps, the transmission throughput decreases from 12 Mbps to 6 Mbps due to deterioration of the status of the transmission path, and the free space 22 of the buffer 17 becomes less than the control onset threshold value “450 Pkt”.

The CPU 14 calculates the decrease ratio and the upper limit value of the input bit rate.

decrease ratio=(free space−decrease ratio set value)/saved period=(450−50)×1500×8/0.5=9.6 Mbps

upper limit value of input bit rate=output bit rate+decrease ratio=6+9.6=15.6 Mbps

The CPU 14 calculates the increase ratio and the lower limit value of the input bit rate.

increase ratio=(increase ratio set value−free space)/saved period=(500−450)×1500×8/0.5=1.2 Mbps

lower limit value of input bit rate=output bit rate−increase ratio=6−1.2=4.8 Mbps

Since the current value of the input bit rate 23 “12 Mbps” falls within a range of the lower limit value of the input bit rate “4.8 Mbps” to the upper limit value of the input bit rate “15.6 Mbps”, the CPU 14 sets the update value of the input bit rate to the current value of the input bit rate 23 “12 Mbps”. Furthermore, since the update value of the input bit rate “12 Mbps” is no more than the maximum value of the data rate “12 Mbps”, the CPU 14 keeps the update value of the input bit rate to 12 Mbps.

Suppose that the current value of the input bit rate 23 is 12 Mbps, the transmission throughput becomes 6 Mbps due to deterioration of the transmission path, and the free space 22 of the buffer 17 becomes 250 Pkt.

The CPU 14 calculates the decrease ratio and the upper limit value of the input bit rate.

decrease ratio=(free space−decrease ratio set value)/saved period=(250−50)×1500×8/0.5=4.8 Mbps

upper limit value of input bit rate=output bit rate+decrease ratio=6+4.8=10.8 Mbps

The CPU 14 calculates the increase ratio and the lower limit value of the input bit rate.

increase ratio=(increase ratio set value−free space)/saved period=(500−250)×1500×8/0.5=6 Mbps

lower limit value of input bit rate=output bit rate−increase ratio=6−6=0 Mbps

Since the current value of the input bit rate 23 “12 Mbps” is greater than the upper limit value of the input bit rate “10.8 Mbps”, the CPU 14 sets the update value of the input bit rate to the upper limit value of the input bit rate “10.8 Mbps”. Furthermore, since the update value of the input bit rate “10.8 Mbps” is no more than the maximum value of the data rate “12 Mbps”, the CPU 14 keeps the update value of the input bit rate to 10.8 Mbps.

<Numerical Example in Recovery of Transmission Throughput>

Suppose that the current value of the input bit rate 23 is 3 Mbps, the transmission throughput increases from 3 Mbps to 12 Mbps due to recovery of the status of the transmission path, and the free space 22 of the buffer 17 becomes less than 80 Pkt.

The CPU 14 calculates the decrease ratio and the upper limit value of the input bit rate.

decrease ratio=(free space−decrease ratio set value)/saved period=(80−50)×1500×8/0.5=0.72 Mbps

upper limit value of input bit rate=output bit rate+decrease ratio=12+0.72=12.72 Mbps

The CPU 14 calculates the increase ratio and the lower limit value of the input bit rate.

increase ratio=(increase ratio set value−free space)/saved period=(500−80)×1500×8/0.5=10.08 Mbps

lower limit value of input bit rate=output bit rate−increase ratio=12−10.08=1.92 Mbps

Since the current value of the input bit rate 23 “3 Mbps” falls within a range of the lower limit value of the input bit rate “1.92 Mbps” to the upper limit value of the input bit rate “12.72 Mbps”, the CPU 14 sets the update value of the input bit rate to the current value of the input bit rate 23 “3 Mbps”. Furthermore, since the update value of the input bit rate “3 Mbps” is no more than the maximum value of the data rate “12 Mbps”, the CPU 14 keeps the update value of the input bit rate to 3 Mbps.

Suppose that the current value of the input bit rate 23 is 3 Mbps, the transmission throughput becomes 12 Mbps due to recovery of the status of the transmission path, and the free space 22 of the buffer 17 becomes 150 Pkt.

The CPU 14 calculates the decrease ratio and the upper limit value of the input bit rate.

decrease ratio=(free space−decrease ratio set value)/saved period=(150−50)×1500×8/0.5=2.4 Mbps

upper limit value of input bit rate=output bit rate+decrease ratio=12+2.4=14.4 Mbps

The CPU 14 calculates the increase ratio and the lower limit value of the input bit rate.

increase ratio=(increase ratio set value−free space)/saved period=(500−150)×1500×8/0.5=8.4 Mbps

lower limit value of input bit rate=output bit rate−increase ratio=12−8.4=3.6 Mbps

Since the current value of the input bit rate 23 “3 Mbps” is less than the lower limit value of the input bit rate “3.6 Mbps”, the CPU 14 sets the update value of the input bit rate to the lower limit value of the input bit rate “3.6 Mbps”. Furthermore, since the update value of the input bit rate “3.6 Mbps” is no more than the maximum value of the data rate “12 Mbps”, the CPU 14 keeps the update value of the input bit rate to 3.6 Mbps.

<Basic Policy of Decrease Control of Input Bit Rate>

The following describes the outline of the basic policy of controlling the input bit rate to decrease in the case where the transmission throughput decreases.

When the status of the transmission path deteriorates and the transmission throughput, that is, the output bit rate of media data output from the buffer 17 decreases, the data rate of the media data, that is, the input bit rate 23 of the media data input to the buffer 17 is controlled to decrease, in order to prevent the occurrence of an overflow of the buffer 17.

In the first embodiment, control is not performed in which the input bit rate 23 is decreased such that the value of the input bit rate 23 is the value of the output bit rate 24, unlike the conventional arts. Instead, control is performed in which the input bit rate 23 is decreased such that the value of the input bit rate 23 is greater than the value of the output bit rate 24, using the free space 22 of the buffer 17. Specifically, a value of the decrease ratio is calculated such that the value of the free space 22 of the buffer 17 is the decrease ratio set value after an elapse of the above saved period. If the current value of the input bit rate 23 is greater than a value resulted from adding the value of the decrease ratio and the value of the output bit rate 24 (the upper limit value of the input bit rate), the input bit rate 23 is controlled such that the value of the input bit rate 23 is the upper limit value of the input bit rate. Note that the value of the free space 22 of the buffer 17 increases or decreases depending on the difference between the value of the input bit rate 23 and the value of the output bit rate 24. Accordingly, in the case where control is performed such that the value of the input bit rate 23 is the upper limit value of the input bit rate, the free space 22 of the buffer 17 decreases depending on the decrease ratio even if the transmission throughput does not vary.

According to the above method of controlling the input bit rate to decrease in the case where the transmission throughput decrease, as the value of the free space 22 of the buffer 17 increases, the value of the decrease ratio to be added to the value of the output bit rate 24 increases and as a result the upper limit value of the input bit rate increases. Accordingly, the amount of decrease of the input bit rate is reduced, compared with the case where the transmission throughput temporarily decreases and the input bit rate 23 is controlled to decrease such that the value of the input bit rate 23 is the transmission throughput, that is, the value of the output bit rate 24. This can suppress the temporal variation of the input bit rate. As a result, in the case where the transmission throughput temporarily decreases during distribution of video data for example, it is possible to reduce an amount of decrease of a resolution or a frame rate of videos played back on an AV apparatus as a reception apparatus. Accordingly, the viewer can watch the videos having a stable quality.

Also, as the value of the free space 22 of the buffer 17 decreases, the value of the decrease ratio to be added to the value of the output bit rate decreases. Control is performed such that the difference between the value of the input bit rate and the value of the output bit rate is reduced as far as the value of the free space 22 of the buffer 17 becomes no more than the decrease ratio set value. As a result, even if the value of the free space 22 of the buffer 17 decreases due to the continuation of the decrease of the transmission throughput for a certain period, the value of the free space 22 of the buffer 17 decreases only down to the decrease ratio set value, and accordingly an overflow of the buffer 17 does not occur. Therefore, even if the decrease of the transmission throughput continues for a certain period during transmission of video data for example, it is possible to prevent the case where packets cannot reach an AV apparatus as a reception apparatus due to the overflow of the buffer 17, and as a result disappear. This enables the viewer to watch videos without being interrupted.

Furthermore, in the case where the value of the free space 22 of the buffer 17 is controlled to be the decrease ratio set value after an elapse of the saved period, the decrease ratio of the free space 22 gradually decreases as the value of the free space 22 of the buffer 17 decreases. Accordingly, it is possible to gradually decrease the value of the input bit rate 23. Therefore, in the case where the transmission throughput decreases during transmission of video data for example, it is possible to gradually decrease a resolution or a frame rate of videos played back on an AV apparatus as a reception apparatus. This can reduce the uncomfortable feeling of the viewer.

Furthermore, by setting the decrease ratio set value to zero, it is possible to maximize the value of the decrease ratio of the free space 22 in the case where the value of the free space 22 of the buffer 17 is set to the decrease ratio set value after an elapse of the saved period. Accordingly, compared with the case where the decrease ratio set value is set to a value greater than zero, it is possible to minimize the amount of decrease of the value of the input bit rate.

<Basic Policy of Increase Control of Input Bit Rate>

The following describes the outline of the basic policy of controlling the input bit rate to increase in the case where the transmission throughput increases.

When the deteriorated status of the transmission path recovers and the transmission throughput, that is, the output bit rate of media data output from the buffer 17 increases, control is performed on the data rate of the media data, that is, the input bit rate 23 of the media data input to the buffer 17 such that the input bit rate 23 increases, in order to provide the viewer with high-resolution videos during distribution of video data for example.

In the first embodiment, the value of the input bit rate 23 is not controlled to increase to be the value of the output bit rate 24, unlike the conventional arts. The value of the input bit rate 23 is controlled to increase to be less than the value of the output bit rate 24, using the free space 22 of the buffer 17. Specifically, a value of the increase ratio is calculated such that the value of the free space 22 of the buffer 17 is the increase ratio set value after an elapse of the above saved period. If the current value of the input bit rate 23 is less than a value (the lower limit value of the input bit rate) resulted from subtracting the value of the increase ratio from the value of the output bit rate 24, the input bit rate 23 is controlled such that the value of the input bit rate 23 is the lower limit value of the input bit rate. Note that the value of the free space 22 of the buffer 17 increases or decreases depending on the difference between the value of the input bit rate 23 and the value of the output bit rate 24. Accordingly, in the case where control is performed such that the value of the input bit rate 23 is the lower limit value of the input bit rate, the free space 22 of the buffer 17 increases depending on the increase ratio even if the transmission throughput does not vary.

According to the above method of controlling the input bit rate to increase when the transmission throughput increases, in the case where the value of the free space 22 of the buffer 17 is controlled to be the increase ratio set value that is greater than the decrease ratio set value after an elapse of the saved period, the increase ratio of the free space 22 gradually decreases as the value of the free space 22 of the buffer 17 increases. Accordingly, it is possible to gradually increase the value of the input bit rate 23. Therefore, in the case where the decreased transmission throughput recovers during transmission of video data for example, it is possible to gradually increase a resolution or a frame rate of videos played back on an AV apparatus as a reception apparatus. This can reduce the uncomfortable feeling of the viewer.

Also, by setting the increase ratio set value to the maximum value of the accumulated amount of the buffer 17, it is possible to maximize the value of the free space 22 of the buffer 17 in the case where the recovery status of the transmission throughput continues. This makes it possible to use the space of the buffer 17 most efficiently.

<Basic Policy of Determining Update Value of Input Bit Rate>

The following describes the outline of the basic policy of determining an update value of an input bit rate.

In the case where communication is performed using a wireless transmission path or a power line transmission path, the transmission throughput minutely varies at each time even if the average of the transmission throughput is substantially constant and stable. Accordingly, in the case where control is performed such that the value of the input bit rate 23 inevitably increases in accordance with the increase of the value of the output bit rate 24 and inevitably decreases in accordance with the decrease of the value of the output bit rate 24, frequent switching occurs between the decrease control of the input bit rate 23 and the increase control of the input bit rate 24.

Suppose that the current control status is a control status in which the input bit rate 23 is controlled such that the value of the input bit rate 23 is inevitably a value resulted from subtracting the value of the increase ratio of the free space 22 from the value of the output bit rate 24. This control status switches to a control status in which the input bit rate 23 is controlled such that the value of the input bit rate 23 is inevitably a value resulted from adding the value of the decrease ratio of the free space 22 to the value of the out bit rate 24. The value of the input bit rate 23 varies from a value, which is obtained by subtracting the value of the increase ratio of the free space 22 from the value of the output bit rate 24, to a value, which is obtained by adding the value of the decrease ratio of the free space 22 to the value of the output bit rate 24. In other words, the value of the input bit rate 23 increases by a value resulted from adding the value of the increase ratio and the value of the decrease ratio, and results in rapid increase. As a result, when the transmission throughput decreases, there occurs the rapid increase of a resolution or a frame rate of videos played back on the AV apparatus 3 as a client apparatus, for example.

In order to avoid the above rapid increase, according to the first embodiment, in the case where the control switches from the control status in which the input bit rate 23 is controlled to increase in accordance with the increase of the transmission throughput to the control status in which the input bit rate 23 is controlled to decrease in accordance with the decrease of the transmission throughput, control is performed such that the current value of the input bit rate 23 is kept while a value (the upper limit value of the input bit rate) resulted from adding the value of the decrease ratio of the free space 22 of the buffer 17 to the value of the output bit rate 24 is greater than the current value of the input bit rate 23.

In other words, if the current value of the input bit rate 23 is greater than the upper limit value of the input bit rate, the update value of the input bit rate is set to the upper limit value of the input bit rate. If the current value of the input bit rate 23 is no more than the upper limit value of the input bit rate, the update value of the input bit rate is set to the current value of the input bit rate.

As a result, it is possible to prevent the value of the input bit rate 23 from rapidly increasing in the case where the recovery status of the transmission throughput again deteriorates. This can stabilize the input bit rate 23. Accordingly, in the case where the recovery status of the transmission throughput again deteriorates, there never occurs the rapid increase of a resolution or a frame rate of videos played back on the AV apparatus 3 as a client apparatus for example. This enables the viewer to watch the videos having a stable quality.

Conversely, suppose that the current control status is a control status in which the input bit rate 23 is controlled to decrease such that the value of the input bit rate 23 is inevitably a value resulted from adding the value of the decrease ratio of the free space 22 to the value of the output bit rate 24. This control status switches to a control status in which the input bit rate 23 is controlled to decrease such that the value of the input bit rate 23 is inevitably a value resulted from subtracting the value of the increase ratio of the free space 22 from the value of the output bit rate 24. The value of the input bit rate 23 varies from a value, which is obtained by adding the value of the decrease ratio of the free space 22 to the value of the output bit rate 24, to a value, which is obtained by subtracting the value of the increase ratio of the free space 22 from the value of the output bit rate 24. In other words, the value of the input bit rate 23 decreases by a value resulted from adding the value of the increase ratio and the value of the decrease ratio, and results in rapid decrease. As a result, when the decreased transmission throughput increases, there occurs rapid decrease of a resolution or a frame rate of videos played back on the AV apparatus 3 as a client apparatus, for example.

In order to avoid the above rapid decrease, according to the first embodiment, in the case where the control switches from the control status in which the input bit rate 23 is controlled to decrease in accordance with the decrease of the transmission throughput to the control status in which the input bit rate 23 is controlled to increase in accordance with the increase of the transmission throughput, control is performed such that the current value of the input bit rate 23 is kept while a value (the lower limit value of the input bit rate) resulted from subtracting the value of the increase ratio of the free space 22 of the buffer 17 from the value of the output bit rate 24 is less than the current value of the input bit rate 23.

In other words, if the current value of the input bit rate 23 is less than the lower limit value of the input bit rate, the update value of the input bit rate is set to the lower limit value of the input bit rate. If the current value of the input bit rate 23 is no less than the lower limit value of the input bit rate, the update value of the input bit rate is set to the current value of the input bit rate.

As a result, it is possible to prevent the value of the input bit rate 23 from rapidly decreasing in the case where the decreased transmission throughput increases. This can stabilize the input bit rate 23. Accordingly, in the case where the decreased transmission throughput increases, there never occurs the rapid decrease of a resolution or a frame rate of videos played back on the AV apparatus 3 as a client apparatus, for example. This enables the viewer to watch the videos having a stable quality.

<Comparison with Conventional Art>

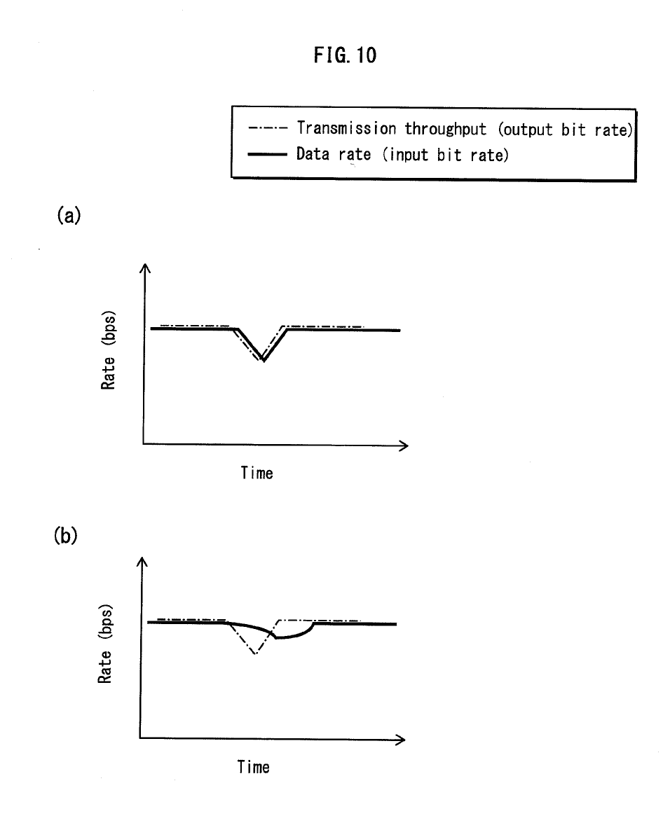

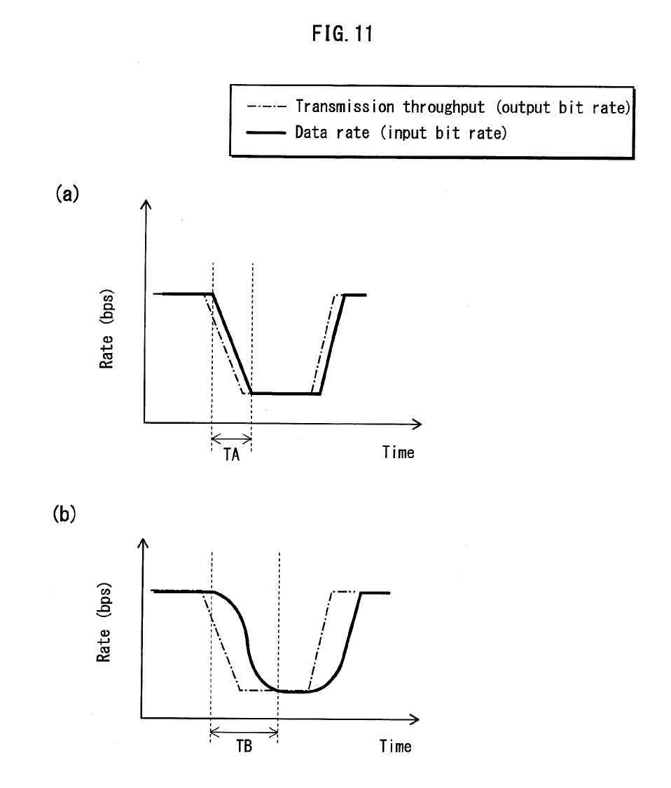

The following compares, in terms of control method of the input bit rate, the first embodiment with the conventional art, with reference to FIG. 10 and FIG. 11. In FIG. 10 and FIG. 11, the vertical axis represents rate (bps), and the horizontal axis represents time.

FIG. 10(a) and FIG. 11(a) each show the temporal variation of the transmission throughput, that is, the output bit rate 24 of media data output from the buffer 17 and the temporal variation of the data rate of data to be transmitted, that is, the input bit rate 23 of media data input to the buffer 17, which are according to a conventional control method of the input bit rate.

FIG. 10(b) and FIG. 11(b) each show the temporal variation of the transmission throughput, that is, the output bit rate 24 of media data output from the buffer 17 and the temporal variation of the data rate of data to be transmitted, that is, the input bit rate 23 of media data input to the buffer 17, which are according to the control method of the input bit rate relating to the first embodiment.

<Comparison in Terms of Input Bit Rate Control Method Between First Embodiment and Conventional Art in Case of Momentary Decrease of Transmission Throughput>

The following compares, in terms of control method of the input bit rate, the first embodiment with the conventional art, with reference to FIG. 10(a) and FIG. 10(b).

According to the control method of the input bit rate relating to the conventional art, the decrease of the value of the input bit rate 23 follows the momentary decrease of the transmission throughput, as shown in FIG. 10(a). Note that in order to prevent occurrence of the overflow of the buffer 17, a time interval for controlling the input bit rate is set short.

Compared with this, according to the control method of the input bit rate relating to the first embodiment, the update value of the input bit rate to be used for updating the input bit rate 23 is set to a value (the upper limit value of the input bit rate) resulted from adding the value of the decrease ratio to the transmission throughput, that is, the value of the output bit rate 24, as shown in FIG. 10(b). Therefore, according to the control method of the input bit rate relating to the first embodiment, the amount of decrease of the input bit rate 24 is reduced, compared with the control method of the input bit rate relating to the conventional art. Accordingly, high-resolution videos can be provided to the viewer for example.

Also, according to the control method of the input bit rate relating to the first embodiment, the update value of the input bit rate to be used for updating the input bit rate 23 is set to a value (the upper limit value of the input bit rate) resulted from adding the value of the decrease ratio to the value of the output bit rate, a value (the lower limit value of the input bit rate) resulted from subtracting the value of the increase ratio from the value of the output bit rate 24, or the like. Accordingly, according to the control method of the input bit rate relating to the first embodiment, the change ratio of the input bit rate 23 is gradual in both the case where the input bit rate 23 is controlled to decrease and the case where the input bit rate 23 is controlled to increase, compared with the control method of the input bit rate relating to the conventional art. Accordingly, it is possible to reduce visual uncomfortable feeling of the viewer, for example.

<Comparison in Terms of Input Bit Rate Control Method Between First Embodiment and Conventional Art in the Case where Amount of Decrease of Transmission Throughput is Large and Decrease Period of Transmission Throughput is Long>

The following compares, in terms of the control method of the input bit rate, the first embodiment with the conventional art, in the case where the amount of decrease of the transmission throughput is large and the decrease period of the transmission throughput is long, with reference to FIG. 11(a) and FIG. 11(b).

According to the control method of the input bit rate relating to the conventional art, the decrease of the value of the input bit rate 23 follows the decrease of the transmission throughput, as shown in FIG. 11(a). Note that in order to prevent occurrence of the overflow of the buffer 17, a time interval for controlling the input bit rate is set short.

Compared with this, according the control method of the input bit rate relating to the first embodiment, the input bit rate is controlled to gradually decrease and then increase as shown in FIG. 11(b), compared with the control method of the input bit rate relating to the conventional art. This can, for example, reduce the visual uncomfortable feeling of the viewer. From the comparison in terms of time period necessary for decreasing the input bit rate 23 for example, it is proved that a time TB relating to the present embodiment (see FIG. 11(b)) is longer than a time TA relating to the conventional art (see FIG. 11(a)). In this way, according to the control method of the input bit rate relating to the first embodiment, control is performed such that the image quality is gradually decreased in a sufficient time period. This can reduce the visual uncomfortable feeling of the viewer, for example.

### Second Embodiment

The following describes a second embodiment of the present invention with reference to the drawings.

In the first embodiment, the AV apparatus 2 as a server apparatus calculates an update value of the input bit rate, and changes a bit rate (data rate) of media data input to the buffer 17 based on the calculated update value of the input bit rate. Compared with this, in the second embodiment, a relay apparatus connected with the AV apparatus 2 as a server apparatus calculates an update value of the input bit rate, and changes a bit rate (data rate) of media data input to the buffer 17 based on the calculated update value of the input bit rate.

Compositional elements of the second embodiment having substantially the same functions as the compositional elements of the first embodiment have the same reference signs of those of the first embodiment. Since the explanation of the first embodiment is applicable to the second embodiment, the explanation of the compositional elements of the second embodiment is omitted here, or only the outline thereof is given.

<Structure and Operations of Network>

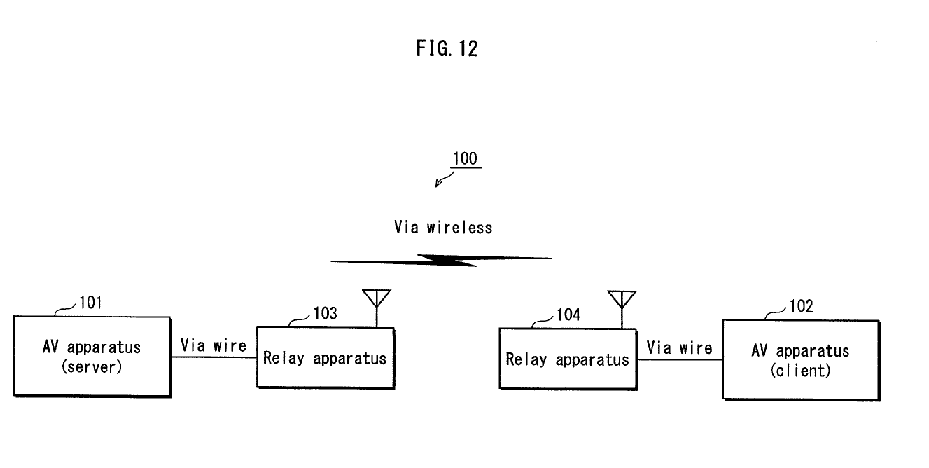

FIG. 12 shows a structure of a network relating to the second embodiment. A network 100 includes AV apparatuses 101 and 102 relay apparatuses 103 and 104.

In the second embodiment, the AV apparatus 101 is an AV apparatus as a server apparatus that transmits media data, and does not control the input bit rate, unlike the AV apparatus 2 as a server apparatus of the first embodiment. The AV apparatus 102 is an AV apparatus as a client apparatus that receives media data transmitted from other apparatus, and plays back and displays the received media data. The AV apparatus 101 is, for example, a recorder that has a communication function and is capable of storing video content data, such as an HDD recorder and a Blu-ray Disk™ recorder. The AV apparatus 102 is, for example, a display that has a communication function such as a TV.

The relay apparatuses 103 and 104 are each an apparatus that relays communication, and are for example a gateway, a router, a bridge, a switching hub, or the like. The relay apparatus 103 controls the input bit rate. The relay apparatuses 103 and 104 each are described here as a wire-wireless bridge.

In the network 100, communication between the AV apparatus 101 and the relay apparatus 103 and communication between the AV apparatus 102 and the relay apparatus 104 are each realized by wire communication. Also, communication between the relay apparatuses 103 and 104 is realized by wireless communication.

The AV apparatus 101 streams video content data accumulated therein, for example. The AV apparatus 102 receives the streamed video content data via the relay apparatuses 103 and 104, and plays back and displays the received video content data. This enables the viewer to watch, on the AV apparatus 102, videos of the video content data accumulated in the AV apparatus 101.

The following describes the details of the relay apparatus 103 connected with the AV apparatus 101 as a server apparatus with reference to the drawings. Note that a prevalent AV apparatus is available for each of the AV apparatuses 101 and 102, and a prevalent relay apparatus is available for the relay apparatus 104 connected to the AV apparatus as a client apparatus. Accordingly, the detailed descriptions thereof are omitted here.

<Structure of Relay Apparatus Connected with AV Apparatus as Server Apparatus>

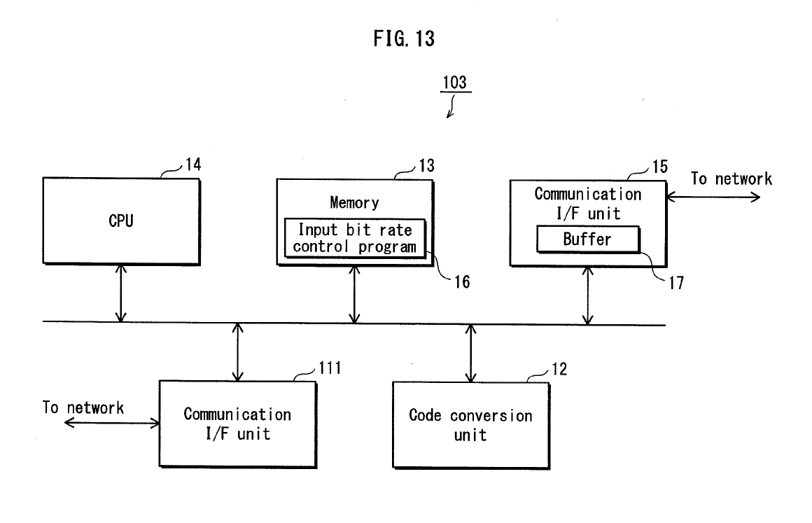

FIG. 13 shows a structure of the relay apparatus 103 connected with the AV apparatus 101 as a server apparatus shown in FIG. 12. The relay apparatus 103 includes a code conversion unit 12, a memory 13 storing therein an input bit rate control program 16, a CPU 14, a communication I/F unit 15 including a buffer 17, and a communication I/F unit 111. Note that the relay apparatus 103 is connected with the relay apparatus 104 via the communication I/F unit 15, and is connected with the AV apparatus 101 via the communication I/F unit 111.

The communication I/F unit 111 has a function of transmitting and receiving data via a network, such as a function of performing modulation and demodulation of data signal and media access control. The communication I/F unit 111 is a communication I/F unit for wireless communication, here.

For example, the communication I/F unit 111 receives media data recorded in the AV apparatus 101 from the AV apparatus 101. The CPU 14 executes the input bit rate control program 16 stored in the memory 13 to calculate an updated value of the input bit rate (see FIG. 6 and FIG. 7). The code conversion unit 12 changes a bit rate (data rate) of the received media data based on the calculated update value of the input bit rate. Then, the communication I/F unit 15 temporarily accumulates the media data whose bit rate has been changed by the code conversion unit 12 in the buffer 17, and transmits the accumulated media data to the relay apparatus 104 via the network. The relay apparatus 104 transmits the received media data to the AV apparatus 102 as a client apparatus.

According to the second embodiment, it is possible to achieve substantially the same effect as the first embodiment.

### Third Embodiment

The following describes a third embodiment of the present invention with reference to the drawings.

In the first embodiment, the AV apparatus 2 as a server apparatus calculates an update value of the input bit rate, and changes a bit rate (data rate) of media data input to the buffer 17 based on the calculated update value of the input bit rate. Compared with this, in the third embodiment, an AV apparatus as a client apparatus calculates an update value of the data rate, which is to be used by an AV apparatus as a server apparatus for changing a bit rate (data rate) of media data, and feeds back the calculated update value of the data rate to the AV apparatus as a server apparatus. The AV apparatus as a server apparatus changes the bit rate (data rate) of media data based on the update value of the data rate fed back from the AV apparatus as a client apparatus.

Compositional elements of the second embodiment that are substantially the same as those of the first embodiment have the same reference numbers as those of the first embodiment. Since the explanation of the first embodiment is applicable to the third embodiment, the explanation of the compositional elements of the third embodiment is omitted here, or only the outline thereof is given.

<Structure and Operations of Network>

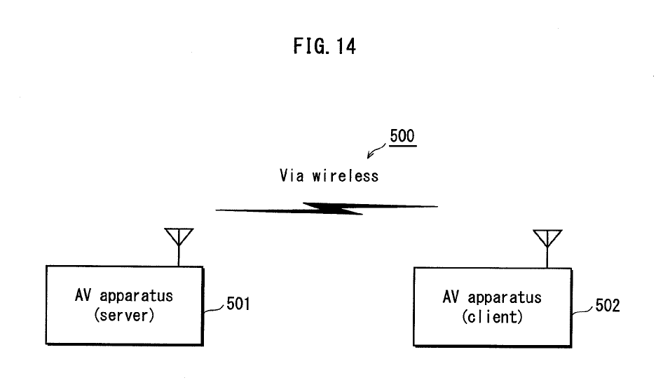

FIG. 14 shows a structure of a network relating to the third embodiment. The network 500 includes AV apparatuses 501 and 502.

In the third embodiment, the AV apparatus 501 is an AV apparatus as a server apparatus that stores therein media data and transmits the stored media data. The AV apparatus 502 is an AV apparatus as a client apparatus that receives media data transmitted from other apparatus, and plays back and displays the received media data. The AV apparatus 501 is, for example, a recorder that has a communication function and is capable of storing video content data, such as an HDD recorder and a Blu-ray Disk™ recorder. The AV apparatus 502 is, for example, a display that has a communication function such as a TV. The communication function is realized by the communications described in the first embodiment, for example. In FIG. 14, the communication function is represented by wireless communication.

The AV apparatus 501 streams video content data accumulated therein, for example. The AV apparatus 502 receives the streamed video content data, and plays back and displays the received video content data. This enables the viewer to watch, on the AV apparatus 502, videos of the video content data accumulated in the AV apparatus 501.

The following describes the details of the AV apparatus 501 as a server apparatus and the AV apparatus 502 as a client apparatus, with reference to the drawings.

<Structure of AV Apparatus (as Server Apparatus)>

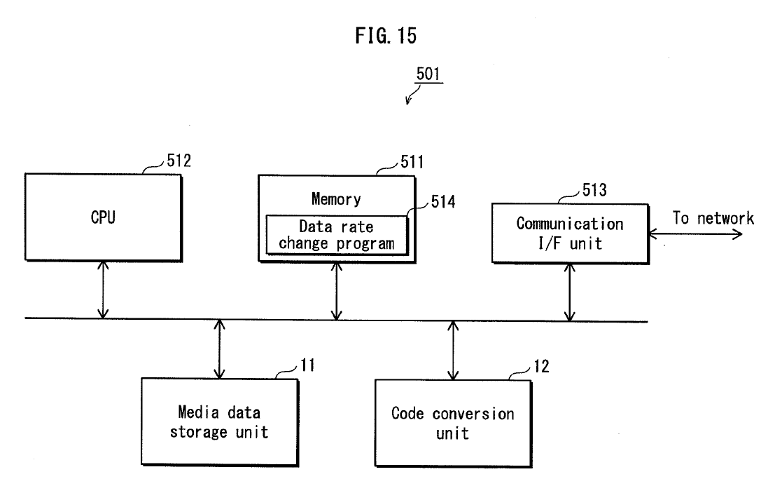

FIG. 15 shows a structure of the AV apparatus 501 as a server apparatus shown in FIG. 14. The AV apparatus 501 includes a media data storage unit 11, a code conversion unit 12, a memory 511, a CPU 512, and a communication I/F unit 513.

The memory 511 is, for example, a semiconductor memory such as a ROM and a RAM. The memory 511 stores therein programs such as various types of control programs and various types of application programs. For example, the memory 511 stores therein a program 514 for analyzing data rate information transmitted from the AV apparatus 502 as a client apparatus and notifying the code conversion unit 12 of an update value of the data rate included in the data rate information. This program 514 is hereinafter referred to as a “data rate change program” 514. Also, the memory 511 has an area to be used by the CPU 512 for performing operations.

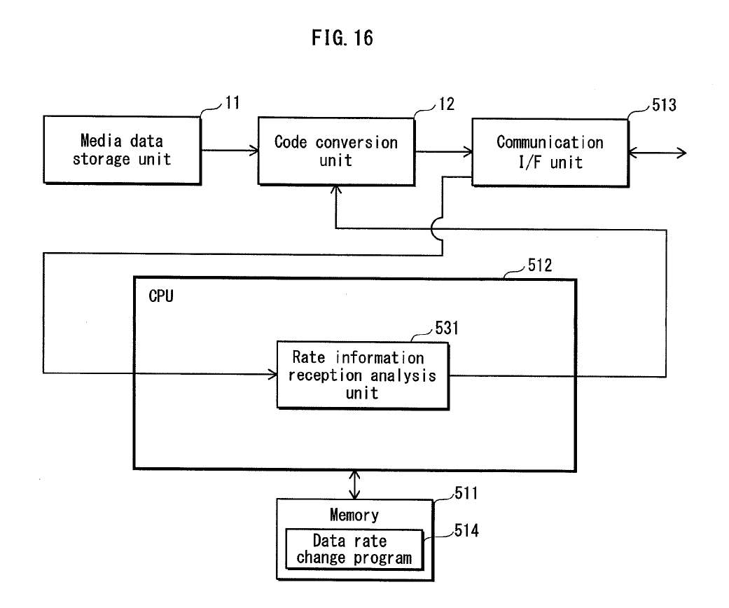

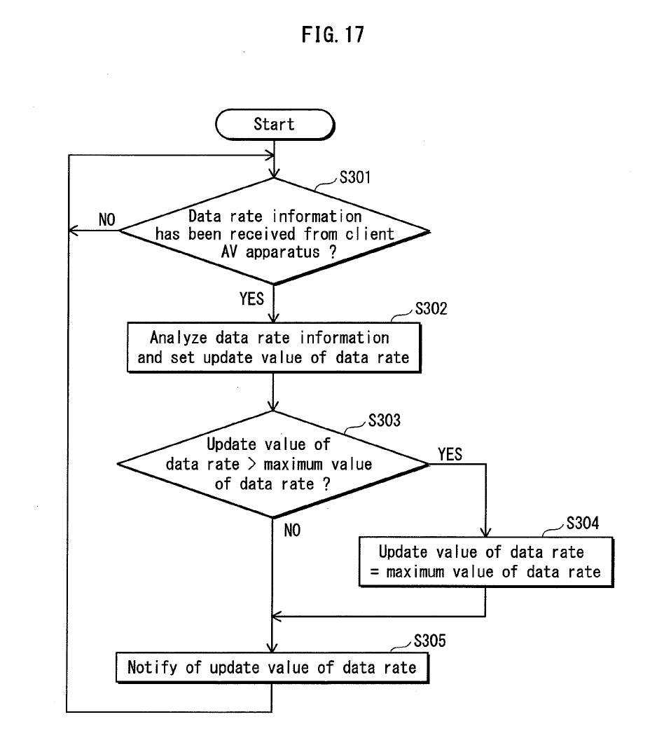

The CPU 512 has a function of performing various types of controls on the whole AV apparatus 501 and performing various types of calculations, by reading a program stored in the memory 511 and executing the read program. For example, the CPU 512 reads the data rate change program 514 from the memory 511, and executes the read data rate change program 514. Note that this processing is described later with reference to FIG. 16 and FIG. 17.

The communication I/F unit 513 has a function of transmitting and receiving data via a network, such as a function of performing modulation and demodulation of data signal and media access control. The communication I/F unit 553 is a communication I/F unit for wireless communication, here. Note that although not shown here, the communication I/F unit 513 has a transmission buffer.

<Functional Structure of CPU>

FIG. 16 shows a functional structure of the CPU 512 shown in FIG. 15. Note that FIG. 16 also shows other compositional elements of the AV apparatus 501 for facilitating understanding of the functional structure of the CPU 512.

The CPU 512 reads the data rate change program 514 stored in the memory 511 and executes the read data rate change program 514, thereby to function as a rate information reception analysis unit 531.

The rate information reception analysis unit 531 receives data rate information transmitted from the AV apparatus 502 as a client apparatus via the communication I/F unit 513, analyzes the received data rate information, and sets the update value of the data rate to an update value of the data rate included in the data rate information. If the update value of the data rate is no more than the maximum value of the data rate that is settable for media data to be transmitted, the rate information reception analysis unit 531 notifies the code conversion unit 12 of the update value of the data rate without changing the update value of the data rate. On the other hand, if the update value of the data rate is greater than the maximum value of the data rate that is settable for media data to be transmitted, the rate information reception analysis unit 531 re-sets the update value of the data rate to the maximum value of the data rate, and notifies the code conversion unit 12 of the re-set update value of the data rate.

Note that the code conversion unit 12 changes a bit rate (data rate) of media data stored in the media data storage unit 11 based on an update value of the data rate notified from the rate information reception analysis unit 531. The code conversion unit 12 outputs the media data whose bit rate has been changed to a buffer included in the communication I/F unit 513 although not shown.

<Operations of CPU>

FIG. 17 is a flow chart showing data rate change processing performed by the CPU 512 shown in FIG. 15. Note that the CPU 512 reads the data rate change program 514 stored in the memory 511 and executes the read data rate change program 514, thereby to perform the processing shown in the flow chart of FIG. 17.

The rate information reception analysis unit 531 of the CPU 512 judges whether data rate information has been received from the AV apparatus 502 as a client apparatus via the communication I/F unit 513 (Step S301). While the rate information reception analysis unit 531 judges that the data rate information has not been received yet (S301: NO), the rate information reception analysis unit 531 repeatedly performs processing of Step S301. If judging that the data rate information has been received (S301: YES), the rate information reception analysis unit 531 analyzes the received data rate information, and sets the update value of the data rate to an update value of the data rate included in the data rate information (Step S302).

The rate information reception analysis unit 531 judges whether the update value of the data rate set in Step S302 (the update value of the data rate included in the received data rate information) is greater than the maximum value of the data rate that is settable for media data to be transmitted (Step S303). If judging that the update value of the data rate set in Step S302 is greater than the maximum value of the data rate (5303: YES), the rate information reception analysis unit 531 re-sets the update value of the data rate to the maximum value of the data rate (Step S304), and notifies the code conversion unit 12 of the update value of the data rate re-set in Step S304 (Step S305). As a result, since the update value of the data rate notified to the code conversion unit 12 never exceeds the maximum value of the data rate, the code conversion unit 12 never changes a bit rate (data rate) of media data based on an update value of the data rate that exceeds the maximum value of the data rate. This can avoid occurrence of an error during change of the bit rate of the media data. On the other hand, if the update value of the data rate set in Step S302 is no more than the maximum value of the data rate (5303: YES), the rate information reception analysis unit 531 notifies the code conversion unit 12 of the update value of the data rate set in Step S302 (Step S305). Note that after the processing of Step S305 is performed, the flow returns to the processing of Step S301.

The code conversion unit 12 changes a bit rate (data rate) of media data stored in the media data storage unit 11 based on the update value of the data rate notified from the rate information reception analysis unit 531, and outputs the media data whose bit rate has been changed to the buffer included in the communication I/F unit 513 although not shown. The communication I/F unit 513 transmits the media data stored in the buffer (not shown) included in the communication I/F unit 513 to the AV apparatus 502 as a client apparatus for example via the network.

<Structure of AV Apparatus (as Client Apparatus)>

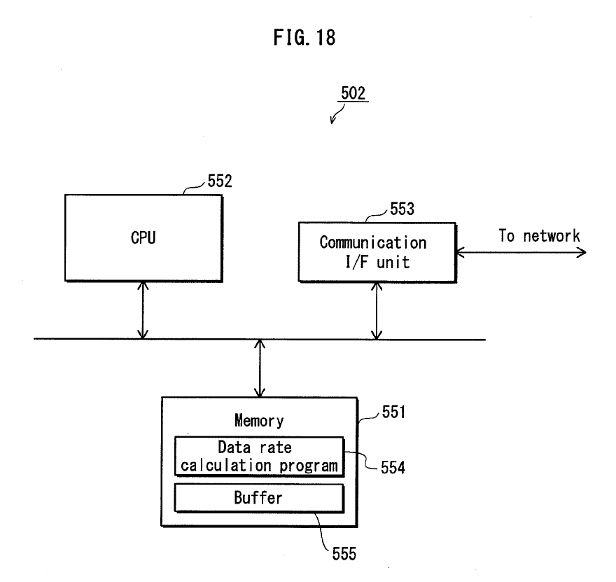

FIG. 18 shows a structure of the AV apparatus 502 as a client apparatus shown in FIG. 14. The AV apparatus 502 includes a memory 551, a CPU 552, and a communication I/F unit 553.

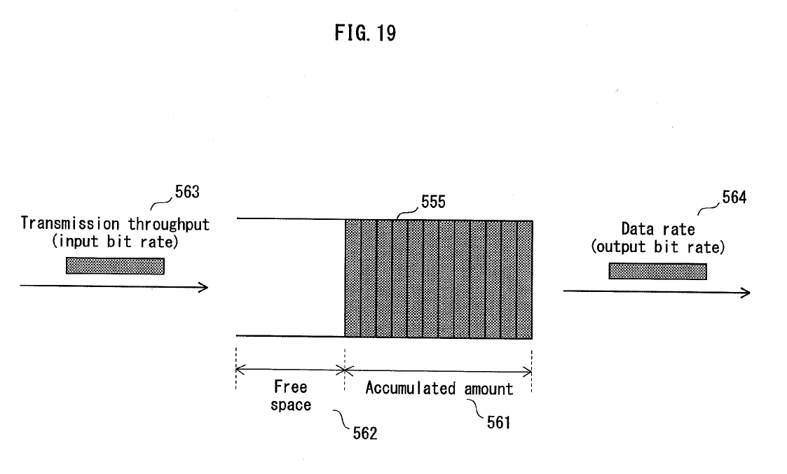

The memory 551 is, for example, a semiconductor memory such as a ROM and a RAM. The memory 551 stores therein programs such as various types of control programs and various types of application programs. For example, the memory 551 stores therein a program 554 to be used by a code conversion unit 12 (see FIG. 15) of the AV apparatus 501 as a server apparatus for determining an update value of the data rate and notifying the AV apparatus 501 as a server apparatus of the determined update value of the data rate. This program 554 is hereinafter referred to as a “data rate calculation program” 554. Also, the memory 551 has an area to be used by a buffer 555 and the CPU 552 for performing operations. The buffer 555 temporarily stores therein media data received by the communication I/F unit 553. Note that the buffer 555 is described later with reference to FIG. 19.

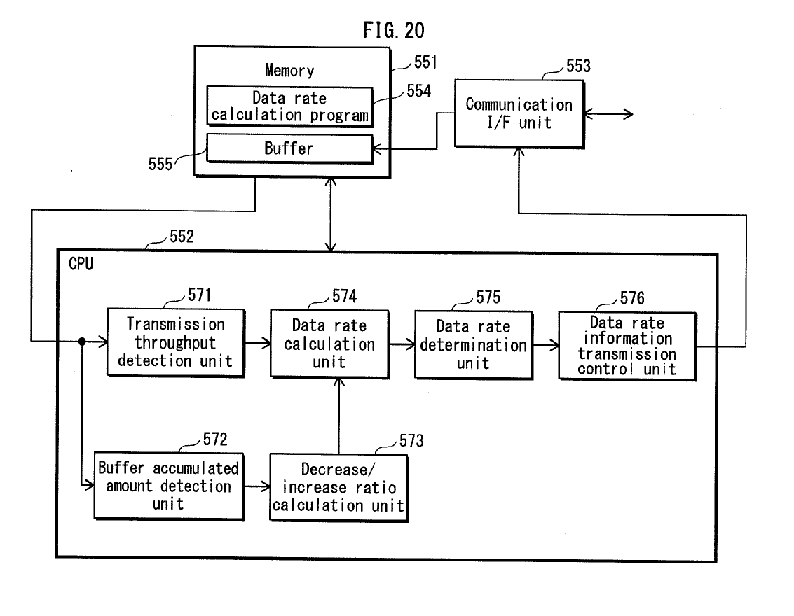

The CPU 552 has a function of performing various types of controls on the whole AV apparatus 502 and performing various types of calculations, by reading a program stored in the memory 551 and executing the read program. For example, the CPU 552 reads the data rate calculation program 554 from the memory 551, and executes the read data rate calculation program 554. Note that this processing is described later with reference to FIG. 20 to FIG. 23.

The communication I/F unit 553 has a function of transmitting and receiving data via a network, such as a function of performing modulation and demodulation of data signal and media access control. The communication I/F unit 553 is a communication I/F unit for wireless communication, here.

<Structure of Buffer>

FIG. 19 shows a structure example of the buffer 555 shown in FIG. 18.

An accumulated amount 561 represents a data amount of data accumulated in the buffer 555. A free space 562 represents a remaining data amount of data accumulatable in the buffer 555. The unit of data amount of the accumulated amount 561 and the free space 562 can be represented by bit, byte, or the like. In the description of the third embodiment, the unit “bit” is used as the unit of data amount.

An input bit rate 563 represents a data amount per unit time of media data input to the buffer 555. An output bit rate 564 represents a data amount per unit time of media data output from the buffer 555. In the description of the third embodiment, the unit “bps (bit per second)” is used as the unit of the input bit rate 563 and the output bit rate 564. Here, the input bit rate 563 is equal to a transmission throughput in the case where the communication I/F unit 553 receives media data. The output bit rate 564 is equal to a bit rate (data rate) of media data output from the code conversion unit 12 (see FIG. 15) of the AV apparatus 502 as a server apparatus.

The buffer 555 outputs media data that has been input in order of the input in accordance with the FIFO principle. Here, if the input bit rate 563 is equal to the output bit rate 564, the accumulated amount 561 of the buffer 555 does not vary. If the input bit rate 563 is not equal to the output bit rate 564, the accumulated amount 561 of the buffer 555 decreases depending on the difference between the input bit rate 563 and the output bit rate 564. In other words, if the input bit rate 563 is greater than the output bit rate 564, the accumulated amount 561 of the buffer 555 increases. If the input bit rate 563 is less than the output bit rate 564, the accumulated amount 561 of the buffer 555 decreases.

For example, if the input bit rate 563 is 12 Mbps and the output bit rate 564 is 8 Mbps, the accumulated amount 561 of the buffer 555 increases at 4 Mbps, in other words, the free space 562 of the buffer 555 decreases at 4 Mbps. On the other hand, if the input bit rate 563 is 6 Mbps and the output bit rate 564 is 9 Mbps, the accumulated amount 561 of the buffer 555 decreases at 3 Mbps, in other words, the free space 562 of the buffer 555 increases at 3 Mbps.

The buffer 555 is for temporarily storing media data until being played back. When the accumulated amount 561 of the buffer 555 reaches zero, that is, when a buffer underflow occurs, data to be played back runs out. This causes interruption of videos or audios. In the third embodiment, in order to prevent occurrence of a buffer underflow as far as possible, the AV apparatus 502 as a client apparatus starts playback of media data after the accumulated amount 561 of the buffer 555 exceeds a certain amount.

<Functional Structure of CPU>

FIG. 20 shows a functional structure of the CPU 552 shown in FIG. 18. Note that FIG. 20 also shows other compositional elements of the AV apparatus 502 for facilitating understanding of the functional structure of the CPU 552.

The CPU 552 reads the data rate calculation program 554 stored in the memory 551, and executes the read data rate calculation program 554. As a result, the CPU 552 functions as a transmission throughput detection unit 571, a buffer accumulated amount detection unit 572, a decrease/increase ratio calculation unit 573, a data rate calculation unit 574, a data rate determination unit 575, and a data rate information transmission control unit 576.

The transmission throughput detection unit 571 detects a value of the input bit rate 563 of media data input to the buffer 555, that is, a transmission throughput, and outputs the detected value of the input bit rate 563, that is, the detected transmission throughput to the data rate calculation unit 574.

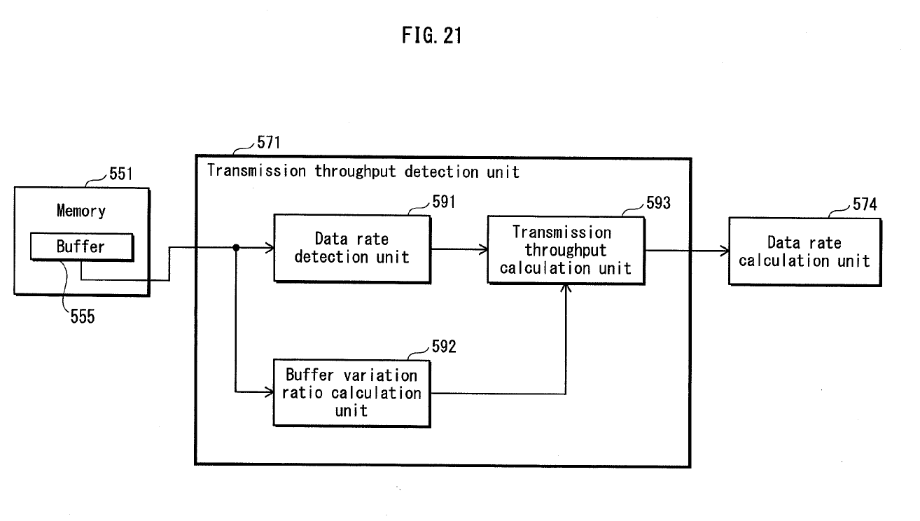

Here, a functional structure of the transmission throughput detection unit 571 is described with reference to FIG. 21. FIG. 21 shows the functional structure of the transmission throughput detection unit 571 shown in FIG. 20. Note that FIG. 21 also shows the memory 551 and the data rate calculation unit 574, for clarifying the connection relationship among the internal elements of the transmission throughput detection unit 571, the memory 551, and the data rate calculation unit 574.

The transmission throughput detection unit 571 functions as a data rate detection unit 591, a buffer variation ratio calculation unit 592, and a transmission throughput calculation unit 593.

The data rate detection unit 591 detects a data amount per unit time of media data output from the buffer 555. Then, the data rate detection unit 591 outputs the detected data amount to the transmission throughput calculation unit 593, as a value of the output bit rate 564 of the media data output from the buffer 555, that is, a value of the data rate of the media data.

Based on the accumulated amount 561 of the buffer 555, the buffer variation ratio calculation unit 592 calculates the increase and the decrease of the accumulated amount 561 per unit time, as a variation ratio. Then, the buffer variation ratio calculation unit 592 outputs the calculated variation ratio to the transmission throughput calculation unit 593. Note that the increase of the accumulated amount 561 as the variation ratio is represented by a positive value and the decrease of the accumulated amount 561 as the variation ratio is represented by a negative value.

The transmission throughput calculation unit 593 subtracts the value of the variation ratio input by the buffer variation ratio calculation unit 592 from the value of the output bit rate 564 input by the data rate detection unit 591, that is, the value of the data rate, to calculate a value of the input bit rate 563, that is, a value of the transmission throughput (input bit rate=output bit rate−variation ratio; transmission throughput=data rate−variation ratio). The transmission throughput calculation unit 593 outputs the calculated value of the transmission throughput to the data rate calculation unit 574.

The buffer accumulated amount detection unit 572 detects a value of the accumulated amount 561 of the buffer 555, and outputs the detected value of the accumulated amount 561 to the decrease/increase ratio calculation unit 573.

The decrease/increase ratio calculation unit 573 calculates a value of a decrease ratio and a value of an increase ratio that are permissible for the accumulated amount 561 of the buffer 555, using the accumulated amount 561 of the buffer 555 input by the buffer accumulated amount detection unit 572. Then, the decrease/increase ratio calculation unit 573 outputs the calculated value of the decrease ratio and the calculated value of the increase ratio to the data rate calculation unit 574.

The decrease/increase ratio calculation unit 573 calculates the increase ratio in the following manner. The decrease/increase ratio calculation unit 573 subtracts the value of the accumulated amount 561 of the buffer 555 from an increase ratio set value which has been set beforehand, and divides a value resulted from the subtraction by a saved period, thereby to calculate a value of the increase ratio (increase ratio=(increase ratio set value−accumulated amount)/saved period). Note that the increase ratio set value is a desired maximum value of the accumulated amount 561 of the buffer 555 after an elapse of the saved period, which is obtained by controlling the output bit rate 564, that is, the data rate to adjust the increase or decrease of the accumulated amount 561 of the buffer 555. The increase ratio set value is used mainly for controlling the output bit rate 564, that is, the data rate to increase. The calculated value of the increase ratio is a value of the increase ratio of the accumulated amount 561 of the buffer 555 per unit time that is necessary for increasing the value of the accumulated amount 561 of the buffer 555 to reach the increase ratio set value after an elapse of the saved period.

Also, the decrease/increase ratio calculation unit 573 calculates the decrease ratio in the following manner. The decrease/increase ratio calculation unit 573 subtracts a decrease ratio set value which has been set beforehand from a value of the accumulated amount 561 of the buffer 555, and divides a value resulted from the subtraction by the saved period, thereby to calculate a value of the decrease ratio (decrease ratio=(accumulated amount−decrease ratio set value)/saved period). Note that the decrease ratio set value is a desired minimum value of the accumulated amount 561 of the buffer 555 after an elapse of the saved period, which is obtained by controlling the output bit rate 564, that is, the data rate to adjust the increase or decrease of the accumulated amount 561 of the buffer 555. The decrease ratio set value is used mainly for controlling the output bit rate 564, that is, the data rate to decrease. The calculated value of the decrease ratio is a value of the decrease ratio of the accumulated amount 561 of the buffer 555 per unit time that is necessary for decreasing the value of the accumulated amount 561 of the buffer 555 to reach the decrease ratio set value after an elapse of the saved period.

Note that the increase ratio set value is greater than the decrease ratio set value. Although the increase ratio set value can be set to an arbitrary value in design processing, the increase ratio set value may be set to the maximum value of the accumulated amount of the buffer 555, for example. Although the decrease ratio set value can be set to an arbitrary value in design processing, the decrease ratio set value may be set to zero, for example. Although the saved periods respectively used for calculating the increase ratio and the decrease ratio can be set to an arbitrary value in design processing, the saved periods may be set to a duration of transmission path errors that continuously occur, for example. Note that the saved periods respectively used for calculating the increase ratio and the decrease ratio may be the same value, or values different from each other.

The data rate calculation unit 574 adds the value of the decrease ratio input by the decrease/increase ratio calculation unit 573 to the value of the input bit rate 563 input by the transmission throughput detection unit 571, that is, the value of the transmission throughput. The data rate calculation unit 574 outputs a value resulted from the addition to the data rate determination unit 575, as the upper limit value of the data rate (upper limit value of data rate=input bit rate+decrease ratio; upper limit value of data rate=transmission throughput+decrease ratio). Note that the upper limit value of the data rate is the upper limit value of the data rate that is permissible for setting an update value of the data rate.

Also, the data rate calculation unit 574 subtracts the value of the increase ratio input by the decrease/increase ratio calculation unit 573 from the value of the input bit rate 563 input by the transmission throughput detection unit 571, that is, the value of the transmission throughput. The data rate calculation unit 574 outputs a value resulted from the subtraction to the data rate determination unit 575, as the lower limit value of the data rate (lower limit value of data rate=input bit rate−increase ratio; lower limit value of data rate=transmission throughput−increase ratio). Note that the lower limit value of data rate is the lower limit value of the data rate that is permissible for setting an update value of the data rate.

The data rate determination unit 575 determines an update value of the data rate based on the current value of the data rate detected by the data rate detection unit 591 shown in FIG. 21 and the upper limit value of the data rate and the lower limit value of the data rate input by the data rate calculation unit 574. Then, the data rate determination unit 575 outputs the determined update value of the data rate to the data rate information transmission control unit 576.

Specifically, if the current value of the data rate falls within a range of the lower limit value of the data rate to the upper limit value of the data rate, the data rate determination unit 575 sets the update value of the data rate to the current value of the data rate. If the current value of the data rate is less than the lower limit value of the data rate, the data rate determination unit 575 sets the update value of the data rate to the lower limit value of the data rate. If the current value of the data rate is greater than the upper limit value of the data rate, the data rate determination unit 575 sets the update value of the data rate to the upper limit value of the data rate.

The data rate information transmission control unit 576 outputs data rate information to the communication I/F unit 553. The data rate information includes the update value of the data rate input by the data rate determination unit 575. The data rate information is transmitted from the communication I/F unit 553 to the AV apparatus 501 as a server apparatus, for example.

According to the structure of the CPU 552 described with reference to FIG. 20 and FIG. 21, just by detecting the status of the buffer 555, specifically, the accumulated amount 561 of the buffer 555, the output bit rate 564, and the variation ratio of the accumulated amount 561 of the buffer 555, it is possible to control the change of the data rate of media data performed by the code conversion unit 12 of the AV apparatus 501 as a server apparatus. This facilitates control of the change of the data rate, and enables the simplification of the structure of the AV apparatus 502.

<Operations of CPU>

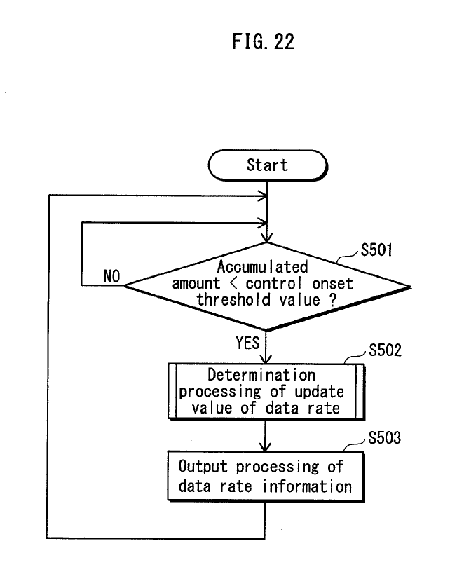

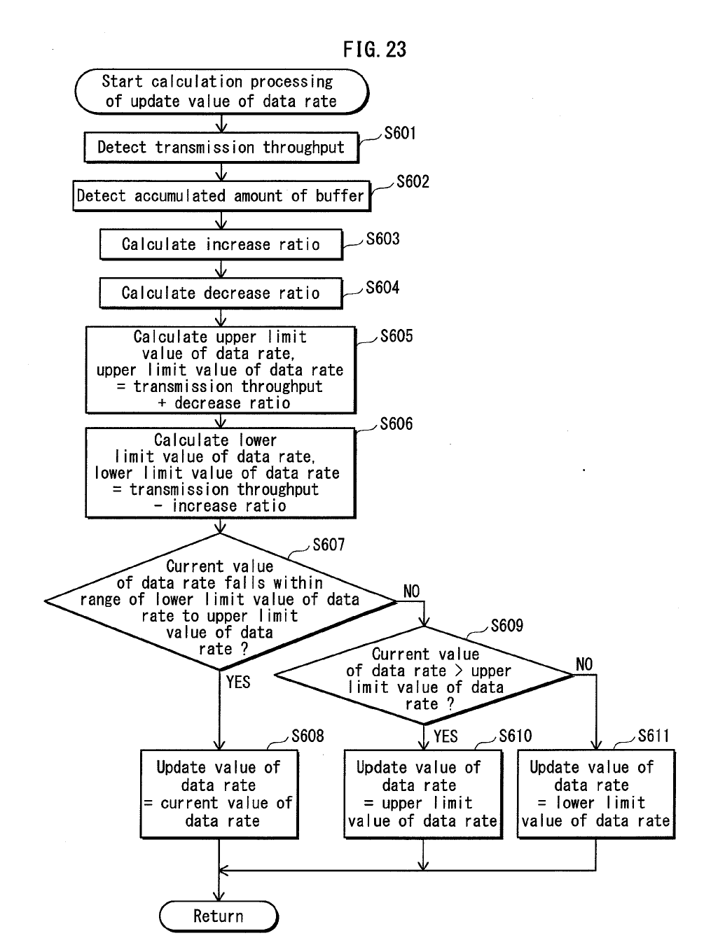

FIG. 22 is a flow chart showing a flow of data rate calculation processing performed by the CPU 552 shown in FIG. 18. Note that the CPU 552 reads the data rate calculation program 554 stored in the memory 551 and executes the read data rate calculation program 554, thereby to perform processing shown in the flow charts of FIG. 22 and FIG. 23 which is described later.

The CPU 552 judges whether the value of the accumulated amount 561 of the buffer 555 is less than a control onset threshold value which has been set beforehand (Step S501).

While the CPU 552 judges that the accumulated amount 561 of the buffer 555 is no less than the control onset threshold value (S501: NO), processing of Step S501 is repeatedly performed, and calculation processing of the data rate is not performed. For example, while the value of the accumulated amount 561 is no less than the control onset threshold value, it is judged that the transmission throughput is stable, and the data rate is not updated. Also, while the value of the accumulated amount 561 becomes no less than the control onset threshold value due to recovery of the deteriorated status of the transmission path and then again becomes less than the control onset threshold value, it is judged that the transmission throughput is stable, and the value of the data rate is fixed to a value of the data rate as of when the value of the accumulated amount 561 becomes no less than the control onset threshold value. In this way, when the value of the accumulated amount 561 of the buffer 555 is no less than the control onset threshold value, it is judged that the transmission throughput is stable. Accordingly, as long as the transmission throughput is stable, the data rate is not updated depending on temporary variation of the accumulated amount 561 of the buffer 555. This can keep the data rate a constant value as long as the transmission throughput is stable. As a result, as long as the transmission throughput is stable, when video data is transmitted, there never occurs a change such as decrease of a resolution or a frame rate of videos played back on the AV apparatus 3 as a client apparatus. Accordingly, the viewer can watch the videos without uncomfortable feeling.

On the other hand, if judging that the accumulated amount 561 of the buffer 555 is less than the control onset threshold value (S501: YES), the CPU 552 performs updated data rate determination processing shown in FIG. 23, thereby to determine an update value of the data rate (Step S502). The data rate information transmission control unit 576 of the CPU 552 outputs data rate information, which includes the update value of the data rate determined in Step S502, to the communication I/F unit 553 (Step S503), and performs processing of Step S501. The communication I/F unit 553 transmits the data rate information input by the data rate information transmission control unit 576 to the AV apparatus 501 as a server apparatus for example, via the network.

<Determination Processing of Update Value of Data Rate>

FIG. 23 is a flow chart showing a flow of determination processing of an update value of the data rate (Step S502) shown in FIG. 22.

In the transmission throughput detection unit 571, the data rate detection unit 591 detects the value of the output bit rate 594 of media data output by the buffer 555, that is, the value of the data rate of the media data, and the buffer variation ratio calculation unit 592 calculates a value of the variation ratio of the accumulated amount 561 of the buffer 555. Then, the transmission throughput calculation unit 593 subtracts the calculated value of the variation ratio from the detected value of the output bit rate 564, that is, the detected value o the data rate, thereby to calculate a value of the input bit rate 563, that is, a value of the transmission throughput (Step S601).

The buffer accumulated amount detection unit 572 detects the value of the accumulated amount 561 of the buffer 555 (Step S602). The decrease/increase ratio calculation unit 573 subtracts the value of the accumulated amount 561 of the buffer 555 detected in Step S602 from the value of the increase ratio set value, and divides a value resulted from the subtraction by the saved period. As a result, a value of the increase ratio is calculated (Step S603). Also, the decrease/increase ratio calculation unit 573 subtracts the decrease ratio set value from the value of the accumulated amount 561 of the buffer 555 detected in Step S602, and divides a value resulted from the subtraction by the saved period. As a result, a value of the decrease ratio is calculated (Step S604).

The data rate calculation unit 574 adds the value of the decrease ratio calculated in Step S604 to the value of the transmission throughput detected in Step S601, and determines a value resulted from the addition as the upper limit value of the data rate (Step S605). Also, the data rate calculation unit 574 subtracts the value of the increase ratio calculated in Step S603 from the value of the transmission throughput detected in Step S601, and determines a value resulted from the subtraction as the lower limit value of the data rate (Step S606).

The data rate determination unit 575 judges whether the current value of the data rate falls within a range of the lower limit value of the data rate determined in Step S606 to the upper limit value of the data rate determined in Step S605 (Step S607).

If judging that the current value of the data rate falls within the range (S607: YES), the data rate determination unit 575 sets the update value of the data rate to the current value of the data rate (Step S608), and performs processing of Step S503 shown in FIG. 22. By performing these processing, in the case where the recovered transmission throughput again decreases, or in the case where the decreased transmission throughput recovers, the data rate is not updated as long as the current value of the data rate falls within the range of the lower limit value of the data rate to the upper limit value of the data rate. Accordingly, as long as the current value of the data rate falls within the above range, the data rate is stable without being varied even if the transmission throughput varies. This can avoid the rapid increase or decrease of the resolution or the frame rate of videos played back on the AV apparatus 502 as a client apparatus, for example. Accordingly, the viewer can watch the videos having a stable quality.

On the other hand, if judging that the current value of the data rate does not fall within the range (S607: NO), the data rate determination unit 575 further judges whether the current value of the data rate is greater than the upper limit value of the data rate (Step S609).

If the data rate determination unit 575 judges that the current value of the data rate is greater than the upper limit value of the data rate (S609: YES), it means that the upper limit value of the data rate is less than the current value of the data rate due to the decrease of the accumulated amount 561 of the buffer 555. Accordingly, the data rate determination unit 575 sets the update value of the data rate to the upper limit value of the data rate in order to decrease the data rate (Step S610), and performs processing of Step S503 shown in FIG. 22.

On the other hand, if the data rate determination unit 575 judges that the current value of the data rate is no more than the upper limit value of the data rate, that is, judges that the current value of the data rate is less than the lower limit value of the data rate (S609: NO), it means that the lower limit value of the data rate is greater than the current value of the data rate due to the increase of the accumulated amount 561 of the buffer 555. Accordingly, the data rate determination unit 575 sets the update value of the data rate to the lower limit value of the data rate in order to increase the data rate (Step S611), and performs processing Step S503 shown in FIG. 22.

<Sequence Example of Updating Data Rate>

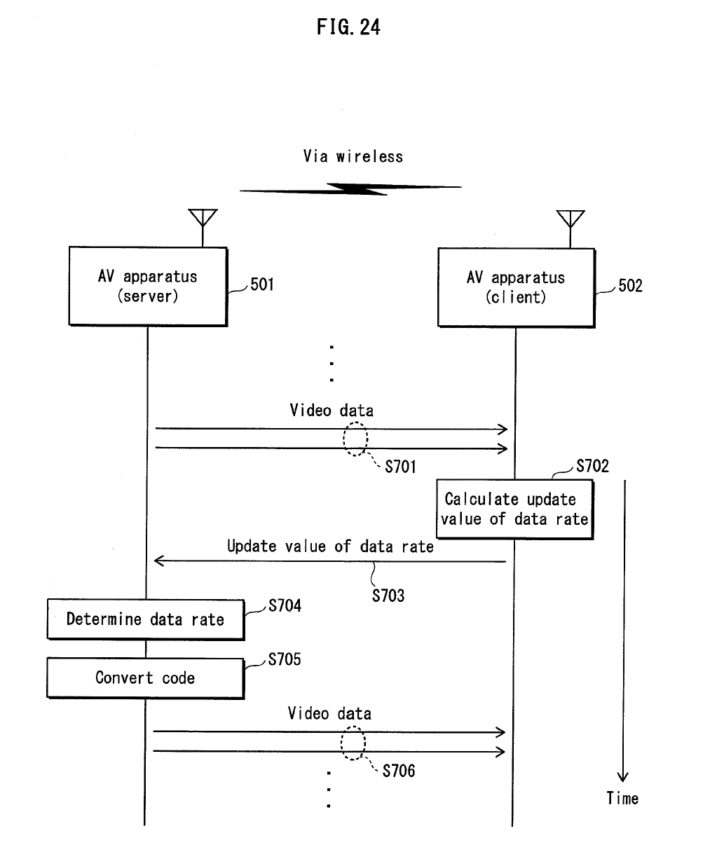

FIG. 24 is a sequence diagram in the case where the AV apparatus 501 as a server apparatus distributes a data stream to the AV apparatus 502 as a client apparatus.

In the AV apparatus 501 as a server apparatus, the code conversion unit 12 changes a bit rate (data rate) of video data stored in the media data storage unit 11. The video data whose bit rate has been changed is streamed via the communication I/F unit 513. The AV apparatus 502 as a client apparatus receives the streamed video data via the communication I/F unit 553, accumulates the received video data in the buffer 555 of the memory 551, and sequentially plays back the accumulated video data (Step S701).

At this time, in the AV apparatus 502 as a client apparatus, the CPU 552 reads the data rate calculation program 554 stored in the memory 551 and executes the read data rate calculation program 554 (see FIG. 22 and FIG. 23), thereby to calculate an update value of the data rate (Step S702). The CPU 552 transmits data rate information, which includes the calculated update value of the data rate, to the AV apparatus 501 via the communication I/F unit 553 (Step S703).

In the AV apparatus 501 as a server apparatus, the CPU 512 reads the data rate change program 514 stored in the memory 511 and executes the read data rate change program 514 (see FIG. 17), thereby determine an update value of the data rate using the update value of the data rate included in the data rate information and the maximum value of the data rate (Step S704). The code conversion unit 12 changes the bit rate (data rate) of the video data stored in the media data storage unit 11 based on the determined update value of the data rate (Step S705). The video data whose bit rate has been changed by the code conversion unit 12 is streamed via the communication I/F unit 513. The AV apparatus 502 as a client apparatus receives the streamed video data via the communication I/F unit 553, accumulates the received video data in the buffer 555 of the memory 551, and sequentially plays back the accumulated video data (Step S706).

This makes it possible to change the data rate of the video data in real time, prevent the underflow of the buffer 555, and prevent the interruption of videos.

<Control Example of Data Rate>

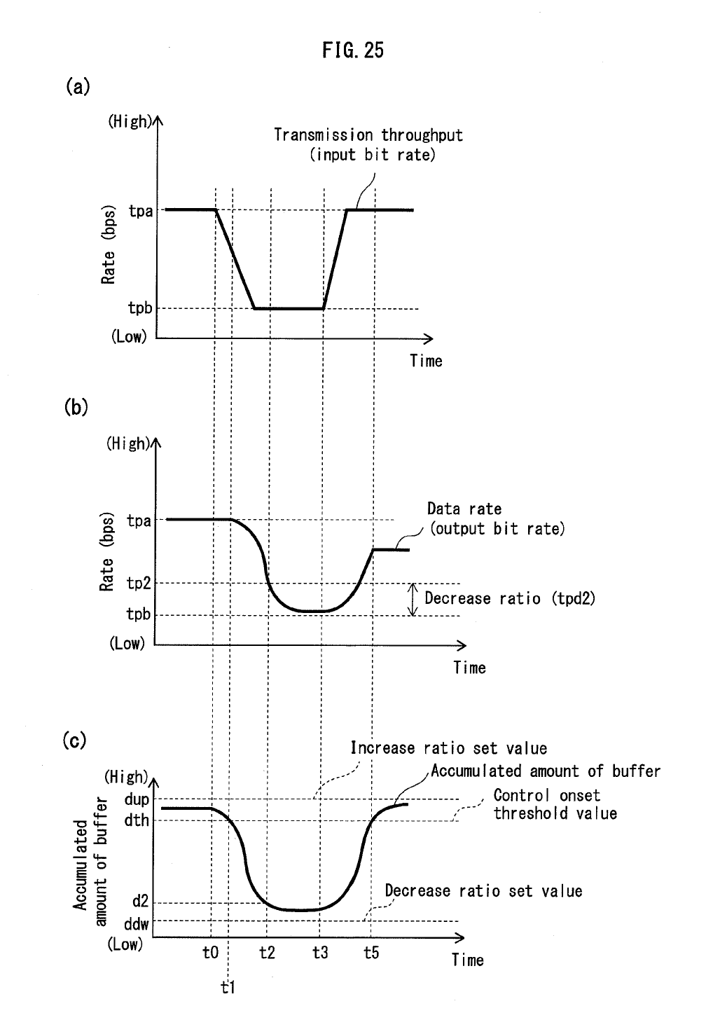

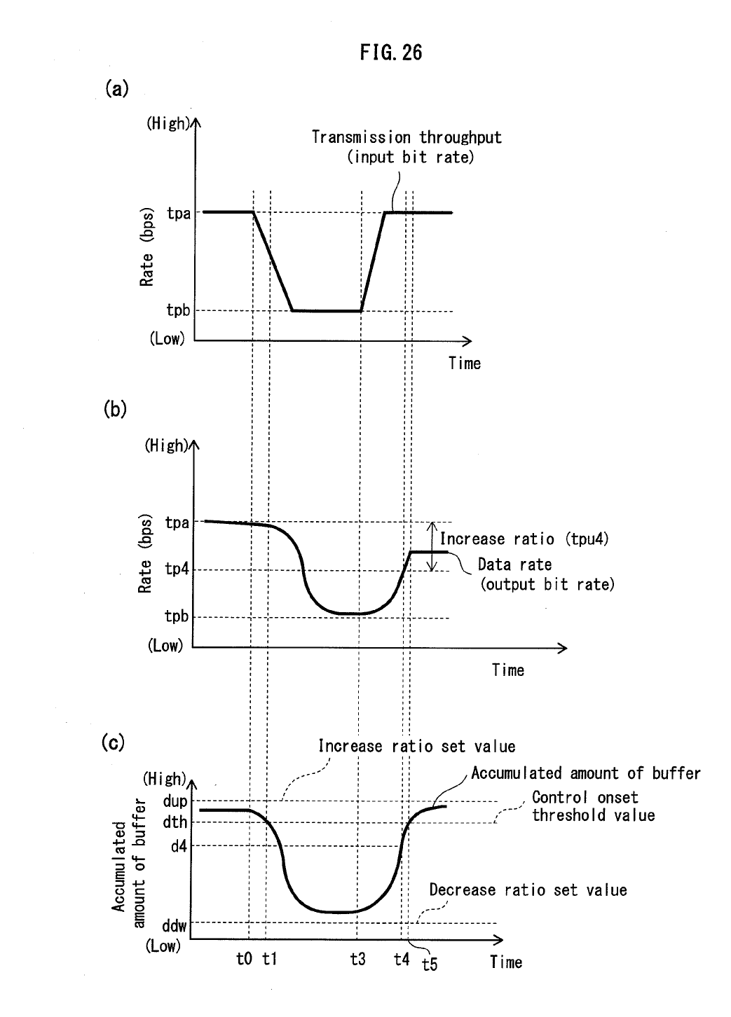

The following describes, as an example of controlling the output bit rate 564, that is, the data rate, the control of an output bit rate of media data output from the buffer 555, that is, a data rate of the media data in the case where the transmission throughput decreases and recovers after an elapse of a constant period, with reference to FIG. 25 and FIG. 26.

FIG. 25(a) and FIG. 26(a) each show the temporal variation of the transmission throughput, that is, the input bit rate 563 of media data input to the buffer 555. The vertical axis represents rate (bps), and the horizontal axis represents time. In FIG. 25(a) and FIG. 26(a), at the time t0, deterioration of the status of the transmission path occurs and the transmission throughput starts rapidly decreasing. At the time t3 after an elapse of a certain time period, the deteriorated status of the transmission path recovers and the transmission throughput starts rapidly increasing.

FIG. 25(b) and FIG. 26(b) each show the temporal variation of the data rate of media data to be received, that is, the output bit rate 564 of media data output from the buffer 555. The vertical axis represents rate (bps), and the horizontal axis represents time.

FIG. 25(c) and FIG. 26(c) each show the temporal variation of the accumulated amount 561 of the buffer 555. The vertical axis represents accumulated amount of buffer, and the horizontal axis represents time.

[Decrease Control of Data Rate in the Case where Transmission Throughput Decreases]

The following describes an example of controlling the output bit rate 564, that is, the data rate in the case where the transmission throughput decreases, with reference to FIG. 25(a) to FIG. 25(c).

At the time t0, the status of the transmission path deteriorates and the transmission throughput, that is, the input bit rate 563 of media data input to the buffer 555 starts decreasing. The value of the input bit rate 563 decreases from tpa to tpb. With the decrease of the input bit rate 563, the accumulated amount 561 of the buffer 555 decreases. Then, till the time t1, the value of the accumulated amount 561 of the buffer 555 is no less than the control onset threshold value dth, and accordingly, the value of the output bit rate 564, that is, the value of the data rate is not changed (see Step S501 in FIG. 22). In this way, while the value of the accumulated amount 561 is no less than the control onset threshold value dth, the value of the output bit rate 564, that is, the value of the data rate does not decrease even if the value of the transmission throughput decreases.

The accumulated amount 561 of the buffer 555 decreases depending on the difference between the value of the input bit rate 563 and the value of the output bit rate 564. Suppose that, at the time t1, the value of the accumulated amount 561 of the buffer 555 becomes less than the control onset threshold value dth. The CPU 552 starts determining the update value of the data rate and transmitting data rate information, which includes the determined update value of the data rate, to the AV apparatus 501 as a server apparatus. Until the value of the accumulated amount 561 of the buffer 555 becomes no less than the control onset threshold value dth, the CPU 552 continues determined the update value of the data value and transmit the data rate information, which includes the determined update value of the data rate, to the AV apparatus 501 as a server apparatus (see FIG. 22).

The transmission throughput detection unit 571 of the CPU 552 detects the value of the input bit rate 563, that is, the value of the transmission throughput. The buffer accumulated amount detection unit 572 detects the value of the accumulated amount 561 of the buffer 555. The decrease/increase ratio calculation unit 573 calculates a value of the increase ratio and a value of the decrease ratio. The data rate calculation unit 574 calculates the upper limit value of the data rate and the lower limit value of the data rate (see Steps S601 to S606 in FIG. 23). Here, the data rate determination unit 575 judges that the current value of the data rate is greater than the upper limit value of the data rate, and sets the update value of the data rate to the upper limit value of the data rate. The data rate information transmission control unit 576 outputs data rate information, which includes the update value of the data rate, to the communication I/F unit 553 (see Steps S607, S609, and S610 in FIG. 23 and Step S503 in FIG. 22). As a result, the value of the data rate gradually decreases while being kept greater than the value of the transmission throughput.

For example, suppose that the decrease ratio set value is ddw, the saved period is ta, the accumulated amount 561 of the buffer 555 at the time t2 is d2, and the input bit rate 563 at the time t2, that is, the transmission throughput is tpb. The decrease ratio at the time t2 represented by tpd2 is as follows: tpd2=(d2−ddw)/ta. The upper limit value of the data rate at the time t2 is tpb+tpd2, which is a value resulted from adding the value of the decrease ratio at the time t2 (tpd2) to the value of the transmission throughput at the time t2 (tpb). The update value of the data rate at the time t2 expressed by tp2 is as follows: tp2=tpb+tpd2.

<Increase Control of Data Rate in the Case where Transmission Throughput Increases>

The following describes an example of controlling the output bit rate 564, that is, the data rate in the case where the transmission throughput increases, with reference to FIG. 26(a) to FIG. 26(c).

Suppose that, at the time t3, the transmission throughput deteriorated due to the deteriorated status of the transmission path recovers due to recovery of the status of the transmission path.

The transmission throughput detection unit 571 of the CPU 552 detects the value of the input bit rate 563, that is, the value of the transmission throughput. The buffer accumulated amount detection unit 572 detects the value of the accumulated amount 561 of the buffer 555. The decrease/increase ratio calculation unit 573 calculates a value of the increase ratio and a value of the decrease ratio. The data rate calculation unit 574 calculates the upper limit value of the data rate and the lower limit value of the data rate (see Steps S601 to S606 in FIG. 23). Here, the data rate determination unit 575 judges that the current value of the data rate is less than the lower limit value of the data rate, and sets the update value of the data rate to the lower limit value of the data rate. The data rate information transmission control unit 576 outputs data rate information, which includes the update value of the data rate, to the communication I/F unit 553 (see Steps S607, 5609, and 5610 in FIG. 23 and Step S503 in FIG. 22). As a result, the value of the data rate gradually increases while being kept less than the value of the transmission throughput.

For example, suppose that the increase ratio set value is dup, the saved period is ta, the accumulated amount 561 of the buffer 555 at the time t4 is d4, and the transmission throughput at the time t4, that is, the input bit rate 563 is tpa. The increase ratio at the time t4 expressed by tpu4 is as follows: tpu4=(dup−d4)/ta. The lower limit value of the data rate at the time t4 is tpa−tpu4, which is a value resulted from subtracting the value of the increase ratio at the time t4 (tpu4) from the value of the transmission throughput at the time t4 (tpa). The update value of the data rate at the time t4 expressed by tp4 is as follows: tp4=tpa−tpu4.

If, at the time t3, the deteriorated status of the transmission path recovers and the transmission throughput, that is, the input bit rate 563 of the media data input to the buffer 555 increases, the accumulated amount 561 of the buffer 555 starts increasing. Then, at the time t5, if the value of the accumulated amount 561 of the buffer 555 becomes no less than the control onset threshold value dth, the output bit rate 564 of media data output from the buffer 555, that is, the data rate of the media data is fixed (see Step S501 in FIG. 22).

<Basic Policy of Decrease Control of Data Rate>

The following describes the basic policy of controlling the output bit rate, that is, the data rate in the case where the transmission throughput decreases.

When the status of the transmission path deteriorates and the transmission throughput decreases, the output bit rate, that is, the data rate is controlled to decrease, in order to prevent the occurrence of an underfloor of the buffer 555.

In the third embodiment, control is not performed in which the output bit rate 564, that is, the data rate is decreased such that the value of the output bit rate 564 is the value of the input bit rate 563. Instead, control is performed in which the output bit rate 564, that is, the data rate is decreased such that the value of the output bit rate 564 is greater than the value of the input bit rate 563, using the accumulated amount 561 of the buffer 555. Specifically, a value of the decrease ratio is calculated such that the value of the accumulated amount 561 of the buffer 555 is the decrease ratio set value after an elapse of the above saved period. If the current value of the data rate is greater than a value (the upper limit value of the data rate) resulted from adding the value of the decrease ratio and the value of the transmission throughput, the data rate is controlled such that the value of the data rate is the upper limit value of the data rate. Note that the value of the accumulated amount 561 of the buffer 555 increases or decreases depending on the difference between the value of the input bit rate 563 and the value of the output bit rate 564. Accordingly, in the case where control is performed such that the value of the output bit rate 563, that is, the value of the data rate is the upper limit value of the data rate, the value of the accumulated amount 561 of the buffer 555 decreases depending on the decrease ratio even if the transmission throughput does not vary.

According to the above method of controlling the data rate in the case where the transmission throughput decreases, as the value of the accumulated amount 561 of the buffer 555 increases, the value of the decrease ratio to be added to the value of the transmission throughput increases and as a result the upper limit value of the data rate increases. Accordingly, in the case where the transmission throughput temporarily decreases, the amount of decrease of the data rate can be further reduced, compared with the case where the output bit rate 564, that is, the data rate is controlled to decrease such that the value of the output bit rate 564 is the value of the input bit rate 563. This can suppress the temporal variation of the data rate. As a result, in the case where the transmission throughput temporarily decreases during distribution of video data for example, it is possible to reduce the amount of decrease of a resolution or a frame rate of videos played back on an AV apparatus as a reception apparatus. Accordingly, the viewer can watch the videos having a stable quality.

Also, as the value of the accumulated amount 561 of the buffer 555 decreases, the value of the decrease ratio to be added to the value of the transmission throughput decreases. Control is performed such that the difference between the value of the input bit rate and the value of the output bit rate is reduced as far as the value of the accumulated amount 561 of the buffer 555 becomes no more than the decrease ratio set value. As a result, even if the value of the accumulated amount 561 of the buffer 555 decreases due to the continuation of the decrease of the transmission throughput, the value of the accumulated amount 561 of the buffer 555 decreases only down to the decrease ratio set value, and accordingly an underflow of the buffer 555 does not occur. Therefore, even if the decrease of the transmission throughput continues for a certain period during transmission of video data for example, there never occurs the interruption of videos due to an underflow of the buffer 555. Accordingly, the viewer can watch the videos without being interrupted.

Furthermore, in the case where the accumulated amount 561 of the buffer 555 is controlled to be the decrease ratio set value after an elapse of the saved period, the decrease ratio of the accumulated amount 561 of the buffer 555 gradually decreases as the value of the accumulated amount 561 of the buffer 555 decreases. Accordingly, it is possible to gradually decrease the value of the data rate. Therefore, in the case where the transmission throughput decreases during transmission of video data for example, it is possible to gradually decrease a resolution or a frame rate of videos played back on an AV apparatus as a reception apparatus. This can reduce the uncomfortable feeling of the viewer.

Furthermore, by setting the decrease ratio set value to zero, it is possible to maximize the value of the decrease ratio of the accumulated amount 561 in the case where the value of the accumulated amount 561 of the buffer 555 is set to the decrease ratio set value after an elapse of the saved period. Accordingly, compared with the case where the decrease ratio set value is set to a value greater than zero, it is possible to minimize the amount of decrease of the value of the data rate.

<Basic Policy of Increase Control of Data Rate>

The following describes the outline of the basic policy of controlling the output bit rate, that is, the data rate in the case where the decreased transmission throughput recovers.

When the deteriorated status of the transmission path recovers and the transmission throughput increases, control is performed on the output bit rate 564 of media data output from the buffer 555, that is, the data rate such that the output bit rate 564 increases, in order to provide the viewer with high-resolution videos during distribution of video data for example.

In the third embodiment, control is not performed in which the output bit rate 564, that is, the data rate is increased such that the value of the output bit rate 564 is the value of the input bit rate 563. Instead, control is performed in which the output bit rate 564, that is, the data rate is increased such that the value of the output bit rate 564 is less than the value of the input bit rate 563, using the accumulated amount 561 of the buffer 555. Specifically, a value of the increase ratio is calculated such that the value of the accumulated amount 561 of the buffer 555 is the increase ratio set value after an elapse of the above saved period. Then, if the current value of the data rate is less than a subtraction value (the lower limit value of the data rate) obtained by subtracting the calculated value of the increase ratio from the value of the transmission throughput, the data rate is controlled such that the value of the data rate is the lower limit value of the data rate. The accumulated amount 561 of the buffer 555 decreases or increases depending on the difference between the input bit rate 563 and the output bit rate 564. Accordingly, in the case where the output bit rate 563, that is, the data rate is controlled so as to be the lower limit value of the data rate, the accumulated amount 561 of the buffer 555 increases depending on the increase ratio even if the transmission throughput does not vary.

According to the above method of controlling the data rate to increase in the case where the decreased transmission throughput recovers, when the value of the accumulated amount 561 of the buffer 555 is controlled to be the increase ratio set value that is greater than the decrease ratio set value after an elapse of the saved period, the increase ratio of the accumulated amount 561 gradually decreases as the value of the accumulated amount 561 of the buffer increases. Accordingly, it is possible to gradually increase the value of the data rate. Therefore, in the case where the decreased transmission throughput recovers during transmission of video data for example, it is possible to gradually increase a resolution or a frame rate of videos played back on an AV apparatus as a reception apparatus. This can reduce the uncomfortable feeling of the viewer.

Also, by setting the increase ratio set value to the maximum value of the accumulated amount of the buffer 555, it is possible to maximize the value of the accumulated amount 561 of the buffer 555 in the case where the recovery status of the transmission throughput remains. This makes it possible to use the space of the buffer 555 most efficiently.

<Basic Policy of Determining Update Value of Data Rate>

The following describes the outline of the basic policy of determining an update value of the data rate.

In the case where communication is performed using a wireless transmission path or a power line transmission path, the transmission throughput minutely varies at each time even if the average of the transmission throughput is substantially constant and stable. Accordingly, suppose that control is performed such that the value of the data rate, that is, the value of the output bit rate 564 increases in accordance with the increase of the value of the transmission throughput, that is, the value of the input bit rate 563 and decreases in accordance with the decrease of the value of the transmission throughput, that is, the value of the input bit rate 563. In such a case, it is expected that frequent switching will occur between the decrease control of the data rate and the increase control of the data rate.

Suppose that the current control status is a control status in which the data rate is controlled such that the value of the data rate is inevitably a value resulted from subtracting the value of the increase ratio of the accumulated amount 671 of the buffer 555 from the value of the transmission throughput. This control status switches to a control status in which the data rate is controlled such that the value of the data rate is inevitably a value resulted from adding the value of the decrease ratio of the accumulated amount 671 of the buffer 555 to the value of the transmission throughput and. The value of the data rate varies from a value, which is obtained by subtracting the value of the increase ratio of the accumulated amount 671 of the buffer 555 from the value of the transmission throughput, to a value, which is obtained by adding the value of the decrease ratio of the accumulated amount 671 of the buffer 555 to the value of the transmission throughput. In other words, the value of the data rate increases by a value resulted from adding the value of the increase ratio and the value of the decrease ratio, and results in rapid increase. As a result, when the transmission throughput decreases, there occurs the rapid increase of a resolution or a frame rate of videos played back on the AV apparatus 502 as a client apparatus, for example.

In order to avoid the above rapid increase, according to the third embodiment, in the case where the control switches from the control status in which the data rate is controlled to increase in accordance with recovery of the transmission throughput to the control status in which the data rate is controlled to decrease in accordance with deterioration of the transmission throughput, control is performed such that the current value of the data rate is kept while a value (the upper limit value of the data rate) resulted from adding the value of the transmission throughput to the value of the accumulated amount 561 of the buffer 555 is greater than the current value of the data rate.

In other words, if the current value of the data rate is greater than the upper limit value of the data rate, the update value of the data rate is set to the upper limit value of the data rate. If the current value of the data rate is no more than the upper limit value of the data rate, the update value of the data rate is set to the current value of the data rate.

As a result, it is possible to prevent the value of the data rate from rapidly increasing in the case where the recovered transmission throughput again decreases. This can stabilize the data rate. Accordingly, in the case where the recovered transmission throughput again deteriorates, there never occurs the rapid increase of a resolution or a frame rate of videos played back by on AV apparatus 502 as a client apparatus, for example. This enables the viewer to watch the videos having a stable quality.

Conversely, suppose that the current control status is a control status in which the data rate is controlled to decrease such that the value of the data rate is inevitably a value resulted from adding the value of the decrease ratio of the accumulated amount 671 of the buffer 555 to the value of the transmission throughput. This control status switches to a control status in which the data rate is controlled to increase such that the value of the data rate is inevitably a value resulted from subtracting the value of the increase ratio of the accumulated amount 671 of the buffer 555 from the value of the transmission throughput. The value of the data rate varies from a value, which is obtained by adding the value of the decrease ratio of the accumulated amount 671 of the buffer 555 to the value of the transmission throughput, to a value, which is obtained by subtracting the value of the increase ratio of the accumulated amount 671 of the buffer 555 from the value of the transmission throughput. In other words, the value of the data rate decreases by a value resulted from adding the value of the decrease ratio to the value of the increase ratio, and results in rapid decrease. As a result, when the decreased transmission throughput recovers, there occurs rapid decrease of a resolution or a frame rate of videos played back on the AV apparatus 502 as a client apparatus, for example.

In order to avoid the above rapid decrease, according to the third embodiment, in the case where the control switches from the control status in which the data rate is controlled to decrease in accordance with deterioration of the transmission throughput to the control status in which the data rate is controlled to increase in accordance with recovery of the transmission throughput, control is performed such that the current value of the data rate is kept while a value (lower limit value of data rate) resulted from subtracting the value of the increase ratio of the accumulated amount 561 of the buffer 555 from the value of the transmission throughput is less than the current value of the data rate.

In other words, if the current value of the data rate is less than the lower limit value of the data rate, the update value of the data rate is set to the lower limit value of the data rate. If the current value of the data rate is no less than the lower limit value of the data rate, the update value of the data rate is set to the current value of the data rate.

As a result, it is possible to prevent the value of the data rate from rapidly decreasing in the case where the decreased transmission throughput recovers. This can stabilize the data rate. Accordingly, in the case where the decreased transmission throughput recovers, there never occurs rapid decrease of a resolution or a frame rate of videos played back on the AV apparatus 502 as a client apparatus, for example. This enables the viewer to watch the videos having a stable quality.

<Supplementary Explanations>

The present invention is not limited to the descriptions of the above embodiments, and is practicable in any embodiment to achieve the object of the present invention and an object that relates to or accompanies the object of the present invention. For example, the following are modification examples.

(1) In the first embodiment, the output bit rate 24 of media data output from the buffer 17 is detected by the output bit rate detection unit 31 having the functional structure shown in FIG. 5. Alternatively, the following may be employed.

For example, the output bit rate 24 of media data output from the buffer 17 may be detected by the following method. The number of successfully transmitted frames per unit time is calculated using the ACK (Acknowledgement) or the NACK (Negative ACK) to calculate a value of the transmission throughput. The calculated value of the transmission throughput is set to a value of the output bit rate. The following is considered as an example of measuring the transmission throughput based on the actual status of the communication. Suppose that an AV apparatus as a server apparatus continuously transmits data of 1500 byte/frame. If the number of ACKs per second is 1000, transmission throughput 1000 (frame)×1500 (byte/frame)/1 (sec) is calculated. As a result, approximately 12 Mbps is obtained as the value of the transmission throughput.

In this way, in the case where the transmission throughput of communication performed by the communication I/F unit 15 is detected as the output bit rate 24, the input bit rate 23 is controlled with use of a value of the transmission throughput that has been actually measured. Accordingly, control of the input bit rate 23 can be surely performed, compared with the case where the output bit rate 24 is calculated based on the input bit rate 23 of media data input to the buffer 17 and the variation ratio of the free space 22 of the buffer 17.

In the third embodiment, the transmission throughput is detected by the transmission throughput detection unit 571 having the functional structure shown in FIG. 21. Alternatively, the following may be employed.

For example, the transmission throughput may be detected by the following method. The number of successfully received frames per unit time is calculated using the CRC (Cyclic Redundancy Check) or the FCS (Frame Check Sequence) to calculate a value of the transmission throughput. The following is considered as an example of measuring the transmission throughput based on the actual status of the communication. Suppose that the AV apparatus 501 as a server apparatus continuously transmits data of 1500 byte/frame. If the number of successfully received frames per second is 1000, transmission throughput=1000 (frame)×1500 (byte/frame)/1 (sec) is calculated. As a result, approximately 12 Mbps is obtained as the value of the transmission throughput.

In this way, in the case where the transmission throughput of communication performed by the communication I/F unit 553 is detected as the input bit rate, the change of the data rate performed by the code conversion unit 12 of the AV apparatus 501 as a server apparatus is controlled, with use of a value of the transmission throughput that has been actually measured. Accordingly, it is possible to surely control the change of the data rate of media data performed by the AV apparatus 501 as a server apparatus, compared with the case where the output bit rate 564 is calculated based on the output bit rate 564 of media data output from the buffer 555 and the variation ratio of the accumulated amount 561 of the buffer 555.

(2) In the first embodiment, when the value of the free space 22 of the buffer 17 becomes no less than the control onset threshold value due to recovery of the decreased transmission throughput, the value of the input bit rate is fixed to a value of the input bit rate as at the time. Alternatively, the value of the input bit rate may be fixed to a predetermined value (for example, the maximum value of the data rate that is settable for media data), for example.

In the third embodiment, when the value of the accumulated amount 561 of the buffer 555 becomes no less than the control onset threshold value due to recovery of the decreased transmission throughput, the value of the data rate is fixed to a value of the data rate as at the time. Alternatively, the value of the data rate may be fixed to a predetermined value (for example, the maximum value of the data rate that is settable for media data), for example.

(3) In the first embodiment, the value of the input bit rate is fixed when the value of the free space 22 of the buffer 17 becomes no less than the control onset threshold value due to recovery of the decreased transmission throughput. Alternatively, the value of the input bit rate may be fixed when the free space 22 of the buffer 17 becomes no less than a threshold value, which is set for example between the control onset threshold value and the increase ratio set value.

In the third embodiment, the value of the data rate is fixed when the value of the accumulated amount 561 of the buffer 555 becomes no less than the control onset threshold value due to recovery of the decreased transmission throughput. Alternatively, the value of the data rate may be fixed when the value of the accumulated amount 561 of the buffer 555 becomes no less than a threshold value, which is set for example between the control onset threshold value and the increase ratio set value.

(4) A wireless communication is used for each of the communication between the AV apparatuses 2 and 3 relating to the first embodiment, the communication between the relay apparatuses 103 and 104 relating to the second embodiment, and the communication between the AV apparatuses 501 and 502 relating to the third embodiment. Alternatively, these communications each may be realized by a power line, a telephone line, a coaxial cable, or an optical cable, for example.

Also, the communication I/F unit 15 relating to the first and second embodiments and the communication I/F units 513 and 553 relating to the third embodiment are each a wireless communication interface. Alternatively, these communication I/F units each may be for example a communication interface such as the Ethernet™, the USB (Universal Serial Bus), the HDMI™ (High-Definition Multimedia Interface), and the IEEE1394.

(5) In the first embodiment, the current value of the input bit rate is compared with each of the lower limit value of the input bit rate and the upper limit value of the input bit rate, and the update value of the input bit rate is set based on a result of the comparison. Alternatively, the following may be employed, for example. In the case where it is detected that the transmission throughput has decreased, the current value of the input bit rate is compared with the upper limit value of the input bit rate. If the current value of the input bit rate is greater than the upper limit value of the input bit rate, the update value of the input bit rate is set to the upper limit value of the input bit rate. If the current value of the input bit rate is no more than the upper limit value of the input bit rate, the update value of the input bit rate is set to the current value of the input bit rate. Also, in the case where it is detected that the transmission throughput has increased, the current value of the input bit rate is compared with the lower limit value of the input bit rate. If the current value of the input bit rate is less than the lower limit value of the input bit rate, the update value of the input bit rate is set to the lower limit value of the input bit rate. If the current value of the input bit rate is no less than the lower limit value of the input bit rate, the update value of the input bit rate is set to the current value of the input bit rate.

In the third embodiment, the current value of the output bit rate, that is, the current value of the data rate is compared with each of the lower limit value of the data rate and the upper limit value of the data rate, and the update value of the data rate is set based on a result of the comparison. Alternatively, the following may be employed, for example. In the case where it is detected that the transmission throughput has decreased, the current value of the data rate is compared with the upper limit value of the data rate. If the current value of the data rate is greater than the upper limit value of the data rate, the update value of the data rate is set to the upper limit value of the data rate. If the current value of the data rate is no more than the upper limit value of the data rate, the update value of the data rate is set to the current value of the data rate. Also, in the case where it is detected that the transmission throughput has increased, the current value of the data rate is compared with the lower limit value of the data rate. If the current value of the data rate is less than the lower limit value of the data rate, the update value of the data rate is set to the lower limit value of the data rate. If the current value of the data rate is no less than the lower limit value of the data rate, the update value of the data rate is set to the current value of the data rate.

(6) In the first embodiment, the order of the processing shown in FIG. 7 may be of course changed as long as processing the same as the processing shown in FIG. 7 is realizable. For example, Steps S204 and S203 may be performed in this order, or Steps S206 and S205 may be performed in this order. Alternatively, Steps S203, S205, S204, and S206 may be performed in this order.

In the third embodiment, the order of the processing shown in FIG. 23 may be of course changed as long as processing the same as the processing shown in FIG. 23 is realizable. For example, Steps S604 and S603 may be performed in this order, or Steps S606 and S605 may be performed in this order. Alternatively, Steps S603, S605, S604, and S606 may be performed in this order.

(7) The first to third embodiments are applicable to various types of data such as video data, audio data, and both of video data and audio data.

(8) The first to third embodiments are applicable to various types of transmission apparatuses and reception apparatuses such an AV apparatus having a communication function and a relay apparatus.

(9) In the first embodiment, information such as the free space 22 of the buffer 17 included in the communication I/F unit 15 is detected. Alternatively, it may be employed to structure a system buffer in the memory 13 and detect information of the system buffer. In the case where the queue size of the buffer 17 cannot be sufficiently secured due to some limitation, it is possible to increase the queue size by further increasing the system buffer of the memory 13. Accordingly, it is possible to easily change the buffer size depending on an application system to be used. As the buffer size increases, the method relating to the first embodiment exhibits the greater effect.

(10) It may be possible to establish a new structure by appropriately combining any of the first to third embodiments. For example, in the third embodiment, it may be possible to establish a network structure in which the AV apparatus 501 as a server apparatus is disconnected from a relay apparatus, in the same way as in the second embodiment.

(11) Each of the apparatuses in the above embodiments is not limited to software operating on a CPU or an MPU. Alternatively, these apparatuses each may be realized by hardware. In this case, the apparatuses are each typically realized as an LSI (Large Scale Integration) that is an integrated circuit. The compositional elements of each of these apparatuses may be separately integrated into one chip, or integrated into one chip including part or all of the compositional elements. Note that although the LSI is used here, the integrated circuit may be variously described as an IC, a system LSI, a super LSI, or a ultra LSI, depending on the level of integration. Note also that the technique used to make an integrated circuit does not have to be LSI. A special-purpose circuit or a general-purpose processor may be used instead. It may be possible to employ an LSI whose configuration can be altered after production such as the programmable FPGA (Field Programmable Gate Array) or a reconfigurable processor that can reconfigure the connection and settings of the circuit cells inside the LSI. Moreover, if, due to progress in the field of semiconductor technology or the derivation of another technology, a technology to replace LSI emerges, that technology may, as a matter of course, be used to integrate the functional block. The use of biotechnology and the like is considered to be a possibility.

(12) Note that the modification examples of the first embodiment described in the Supplementary Explanations are applicable to the second embodiment.

### INDUSTRIAL APPLICABILITY

The present invention is applicable to the control of a data rate of data to be transmitted depending on the status of a transmission path.

### EXPLANATION OF REFERENCE

1: network
2: AV apparatus (as server apparatus)
3: AV apparatus (as client apparatus)
11: media data storage unit
12: code conversion unit
13: memory
14: CPU
15: communication I/F unit
16: input bit rate control program
17: buffer
31: output bit rate detection unit
32: free space detection unit
33: decrease/increase ratio calculation unit
34: input bit rate calculation unit
35: input bit rate determination unit
41: input bit rate detection unit
42: buffer variation ratio calculation unit
43: output bit rate calculation unit

1. A transmission apparatus that transmits data to a transmission path, the transmission apparatus comprising:
a buffer operable to temporarily store therein data to be transmitted to the transmission path;
a first detection unit operable to detect a value of an output rate representing a data amount per predetermined time of data output from the buffer;
a second detection unit operable to detect a value of a free space of the buffer;
a decrease ratio calculation unit operable to calculate a value of a decrease ratio of the free space, by subtracting a predetermined first set value from the value of the free space detected by the second detection unit and dividing a value resulted from the subtraction by a predetermined period; and
a control unit operable, in order to decrease an input rate in accordance with the value of the output rate detected by the first detection unit, to perform rate control processing of (a) adding the detected value of the output rate and the value of the decrease ratio calculated by the decrease ratio calculation unit, and (b) controlling the input rate based on a first control value that is a value resulting from the addition.

2. The transmission apparatus of claim 1, further comprising
an increase ratio calculation unit operable to calculate a value of an increase ratio of the free space, by subtracting the detected value of the free space from a predetermined second set value and dividing a value resulted from the subtraction by a predetermined period, the second set value being greater than the first set value, wherein
in order to increase the input rate in accordance with the detected value of the output rate, the control unit subtracts the value of the increase ratio calculated by the increase ratio calculation unit from the detected value of the output rate, and controls the input rate based on a second control value that is a value resulted from the subtraction.

3. The transmission apparatus of claim 1, wherein
if the detected value of the free space is less than a predetermined first threshold value, the control unit performs the rate control processing.

4. The transmission apparatus of claim 2, wherein
if the detected value of the free space is no less than a predetermined second threshold value, the control unit controls the input rate such that a value of the input rate is a fixed value or a predetermined value.

5. The transmission apparatus of claim 2, wherein
if a current value of the input rate is greater than the first control value, the control unit controls the input rate such that the value of the input rate is the first control value, and
if the current value of the input rate is less than the second control value, the control unit controls the input rate such that the value of the input rate is the second control value.

6. The transmission apparatus of claim 5, wherein
if the current value of the input rate is no less than the second control value and no more than the first control value, the control unit controls the input rate such that the current value of the input rate is kept.

7. The transmission apparatus of claim 1, wherein
if the first control value is greater than a maximum value of the data rate that is settable for data to be transmitted, the control unit controls the input rate such that a value of the input rate is the maximum value of the data rate.

8. The transmission apparatus of claim 2, wherein
if the second control value is greater than a maximum value of the data rate that is settable for data to be transmitted, the control unit controls the input rate such that a value of the input rate is the maximum value of the data rate.

9. A reception apparatus that receives data from a transmission path, the reception apparatus comprising:
a buffer operable to temporarily store therein data received from the transmission path;
a first detection unit operable to detect a value of an input rate that represents a data amount per predetermined time of data input to the buffer;
a second detection unit operable to detect a value of an accumulated amount of data stored in the buffer;
a decrease ratio calculation unit operable to calculate a value of a decrease ratio of the accumulated amount, by subtracting a predetermined first set value from the value of the accumulated amount detected by the second detection unit and dividing a value resulted from the subtraction by a predetermined period; and
a control unit operable, in order to decrease an output rate in accordance with the value of the input rate detected by the first detection unit, to perform rate control processing of (a) adding the detected value of the input rate and the value of the decrease ratio calculated by the decrease ratio calculation unit, (b) determining an update value of the output rate based on a first control value that is a value resulting from the addition, and (c) notifying a transmission apparatus of the determined update value of the output rate.

10. The reception apparatus of claim 9, further comprising
an increase ratio calculation unit operable to calculate a value of an increase ratio of the accumulated amount, by subtracting the detected value of the accumulated amount from a predetermined second set value and dividing a value resulted from the subtraction by a predetermined period, the second set value being greater than the first set value, wherein
in order to increase the output rate in accordance with the detected value of the input rate, the control unit subtracts the value of the increase ratio calculated by the increase ratio calculation unit from the detected value of the input rate, and determines the update value of the output rate based on a second control value that is a value resuled from the subtraction, and notifies the transmission apparatus of the determined update value of the output rate.

11. The reception apparatus of claim 9, wherein
if the detected value of the accumulated amount is less than a predetermined first threshold value, the control unit performs the rate control processing.

12. The reception apparatus of claim 10, wherein
if the detected value of the accumulated amount is no less than a predetermined second threshold value, the control unit determines the update value of the output rate such that a value of the output rate is a fixed value or a predetermined value.

13. The reception apparatus of claim 10, wherein
if a current value of the output rate is greater than the first control value, the control unit determines the update value of the output rate as the first control value, and
if the current value of the output rate is less than the second control value, the control unit determines the update value of the output rate as the second control value.

14. The reception apparatus of claim 13, wherein
if the current value of the output rate is no less than the second control value and no more than the first control value, the control unit determines the update value of the output rate such that the current value of the output rate is kept.

15. A rate control apparatus, comprising:
a buffer operable to temporarily store therein data to be transmitted to the transmission path;
a first detection unit operable to detect a value of an output rate representing a data amount per predetermined time of data output from the buffer;
a second detection unit operable to detect a value of a free space of the buffer;
a decrease ratio calculation unit operable to calculate a value of a decrease ratio of the free space, by subtracting a predetermined first set value from the value of the free space detected by the second detection unit and dividing a value resulted from the subtraction by a predetermined period; and
a control unit operable, in order to decrease an input rate in accordance with the value of the output rate detected by the first detection unit, to perform rate control processing of (a) adding the detected value of the output rate and the value of the decrease ratio calculated by the decrease ratio calculation unit, and (b) controlling the input rate based on a first control value that is a value resulting from the addition.

16. A rate control apparatus, comprising:
a buffer operable to temporarily store therein data received from the transmission path;
a first detection unit operable to detect a value of an input rate that represents a data amount per predetermined time of data input to the buffer;
a second detection unit operable to detect a value of an accumulated amount of data stored in the buffer;
a decrease ratio calculation unit operable to calculate a value of a decrease ratio of the accumulated amount, by subtracting a predetermined first set value from the value of the accumulated amount detected by the second detection unit and dividing a value resulted from the subtraction by a predetermined period; and
a control unit operable, in order to decrease an output rate in accordance with the value of the input rate detected by the first detection unit, to perform rate control processing of (a) adding the detected value of the input rate and the value of the decrease ratio calculated by the decrease ratio calculation unit, (b) determining an update value of the output rate based on a first control value that is a value resulting from the addition, and (c) notifying a transmission apparatus of the determined update value of the output rate.

17. A transmission method for use in a transmission apparatus that transmits data to a transmission path, the transmission method comprising:
a storage step of temporarily storing, in a buffer, data to be transmitted to the transmission path;
a first detection step of detecting a value of an output rate representing a data amount per predetermined time of data output from the buffer;
a second detection step of detecting a value of a free space of the buffer;
a decrease ratio calculation step of calculating a value of a decrease ratio of the free space, by subtracting a predetermined first set value from the value of the free space detected by the second detection step and dividing a value resulted from the subtraction by a predetermined period; and
a control step of, in order to decrease an input rate in accordance with the value of the output rate detected by the first detection step, to perform rate control processing of (a) adding the detected value of the output rate and the value of the decrease ratio calculated by the decrease ratio calculation step, and (b) controlling the input rate based on a first control value that is a value resulting from the addition.

18. A reception method for use in a reception apparatus that receives data from a transmission path, the reception method comprising:
a storage step of temporarily storing, in a buffer, data received from the transmission path;
a first detection step of detecting a value of an input rate that represents a data amount per predetermined time of data input to the buffer;
a second detection step of detecting a value of an accumulated amount of data stored in the buffer;
a decrease ratio calculation step of calculating a value of a decrease ratio of the accumulated amount, by subtracting a predetermined first set value from the value of the accumulated amount detected by the second detection step and dividing a value resulted from the subtraction by a predetermined period; and
a control step of, in order to decrease an output rate in accordance with the value of the input rate detected by the first detection step, performing rate control processing of (a) adding the detected value of the input rate and the value of the decrease ratio calculated by the decrease ratio calculation step, (b) determining an update value of the output rate based on a first control value that is a value resulting from the addition, and (c) notifying a transmission apparatus of the determined update value of the output rate.
